(19) United States
(12) Patent Application Publication
(10) Pub. No.: US 2009/0216552 A1
(43) Pub. Date: Aug. 27, 2009

(54) SYSTEMS AND PROCESSES FOR MAINTAINING ROOFS

(75) Inventor: Leslie P. Watrous, Orange, CA (US)

Correspondence Address: KELLY LOWRY & KELLEY, LLP, 6320 CANOGA AVENUE, SUITE 1650, WOODLAND HILLS, CA, 91367, US

(73) Assignee: CERT-A-ROOF, LLC, Orange, CA (US)

(21) Appl. No.: 12/432,932

(22) Filed: Apr. 30, 2009

Related U.S. Application Data
(63) Continuation-in-part of application No. 10/094,874, filed on Mar. 11, 2002.

(51) Int. Cl. G06Q 10/00; G08B 21/00; G08B 1/08; E04G 23/03; G06F 17/30; H04L 29/06

(52) U.S. Cl. 705/1; 340/540; 340/539.1; 52/741.3; 707/E17.01; 707/10; 713/150

(57) ABSTRACT

The process for maintaining a roof includes receiving a maintenance request and establishing an account in the database associated with the maintenance request. Next, a contractor is notified of the maintenance request. The contractor receives maintenance request information over a communication network by accessing a software application. Performance of the maintenance request is regulated by the software application and a service procedure established in the database.

### BACKGROUND OF THE INVENTION

The present invention relates to roof maintenance. More particularly, the present invention relates to systems and processes for inspecting and certifying roof structures and for conducting repairs of certified roofs during the certification period.

A homeowner or occupant of a structure having a roof may not immediately identify that the roof has any damage. Oftentimes, the warning signs of roofs that are wearing down are unobvious. Even if the owner or occupant is aware of any damage to the roof, the full extent of such damage may not be fully appreciated until the damage becomes readily noticeable. Oftentimes, roof damage is small at first. For example, shingles may be blown off a roof in a windstorm. Over time, this small damage can allow water and environmental elements to work into the structure underlying the roof. This can cause leaks in the interior of the house or damage structures supporting the roof. The roof may eventually require entire replacement if the small damage is not periodically repaired. Even worse, water leakage that causes structural damage to the interior of the house or structures supporting the roof tend to be costly. Thus, it is evident that, over time, relatively small amounts of roof damage can escalate into a serious and expensive problem for the owner of the house or structure.

Even if the house or structure owner is aware that the roof is damaged and requires repair or replacement, the owner is still left with the daunting task of finding a reputable and honest contractor to will fix the roof. One common problem with finding a reputable and honest contractor is the price reflected in the quote for fixing the problem. Even after having an inspection and an appraisal, the owner may be left wondering whether the appraisal and cost estimate for the job is accurate. To this extent, the owner of the structure may request several inspections and appraisals resulting in different analyses and cost estimates. Commonly, differences in the cost estimates and appraisals are due to several factors, including the thoroughness of the inspection.

Furthermore, the structure owner may not be fully aware that an insurance policy or other warranty may cover the structure and pay for the repair of the roof under certain circumstances. Even if the structure owner is aware of such insurance coverage, the owner may not know whether the damage to the roof is covered under the insurance policy or whether the damage occurred by normal wear and tear or other uninsured causes. Such information can only truly be revealed through an effective and thorough inspection of the roof and any accompanying damage. Currently, there are no systems or processes available for ensuring homeowners that such inspections, certifications or repairs are thorough and at least meet minimum industry standards. Such systems or processes should verify the quality of the inspection and any resultant repair work to ensure compliance with these standards.

Accordingly, there is a need for systems and processes for inspecting, certifying and repairing roof structures that helps the owner of the structure ascertain the extent of the damage to the roof, the repairs necessary to fix the roof and the associated costs with repairing the roof. Moreover, such systems and processes should include a database for facilitating the inspection, repair and certification processes, should include a communication network through which the database communicates with a software application accessible either locally or remotely by contractors, should enhance client responsiveness and the quality and accuracy of the roof inspection, certification and repair processes, and should provide assistance with preparing and filing insurance claims for the damage. The present invention fulfills these needs and provides further related advantages.

### SUMMARY OF THE INVENTION

The process for maintaining a roof as disclosed herein includes receiving a maintenance request from a client and establishing an account in a database associated with the maintenance request. The maintenance request itself may include a roof inspection, certification or repair request, a mold free request or a request to verify that the roof structure is sound. A client may initiate the maintenance request via email or text message in response to a certification reminder automatically generated by a database in the roof maintenance system. Accordingly, a contractor capable of facilitating the services requested by the client in the maintenance request is notified. Notification of the contractor may include messaging, calling, texting or emailing the contractor. Such notification may include the details of the maintenance request entered into the database. The contractor can be any inspector, repairman, builder or other related service person capable of carrying out the requisite services. In one embodiment, the contractor is charged a fee for receiving the maintenance request notification.

Next, the roof maintenance system communicates maintenance request information over a communication network to a software application accessible by the contractor. The maintenance request information may include a roof inspection, certification, repair or service history report associated with the client account in the database. The information is preferably sent over a communication network that includes the Internet, a telephone line, a cell phone communication network, a wireless network, or any other known data or communication network. Accordingly, the data communication is secured for transmission through the communication network by secure socket layer (SSL), hyper text transfer protocol secure, transport layer security or encryption. Only those contractors registered with the database have access to the software application. In this regard, the software application may include a stand-alone computer program or an internet-enabled web browser. The contractor is authenticated or otherwise logs into the software application using credentials that grant the contractor access to the database based on registration, a training record, or other criteria for governing access of a contractor with the database. An established service procedure in the database effectively governs and regulates the servicing of the maintenance request through the software application. Updated service procedures may be uploaded to the stand-alone computer program upon authentication by the contractor or otherwise conveyed to the contractor through the internet-enabled web browser. Successful performance of the maintenance request requires compliance with the service procedure through the software application. Failing to satisfy one or more criteria in the service procedure effectively prevents the contractor from fulfilling the maintenance request and closing out the maintenance request in the database.

Regulating performance of the maintenance request by the contractor via the service procedure and the software application ensures that the maintenance request meets minimum standardization requirements. Synchronizing the software application with the database over the communication network ensures compliance with these standards and also ensures that the contractor follows the most up-to-date service procedures, which may vary according to local or state law. Obviously, the maintenance request requirements may change over time and are, accordingly, updated in the software application when synchronized with the database. In one embodiment, the software application is used to regulate diagnosing a leak. Once the contractor ascertains the cause of the leak, the software application may be used to automatically prepare a repair estimate or a repair work order in order to obtain approval to perform the requested maintenance services. The contractor is required to fully document any maintenance request, including inspection, certification or repair of a roof, which requires sending service information from the software application to the database. The service information received may include notes, pictures, observation resolutions or diagrams inputted into the software application by the contractor. Accordingly, the database aggregates service information from multiple contractors into a single client account in the database. The contractor submitting the service information is similarly recorded with the submitted service information in the client account. Completion of the service request depends on performance of the service procedure. The software application may, for example, deny a roof certification for failure to satisfy the service procedure. In this regard, the software application may alert the contractor of a step in the service procedure that is incomplete. The alert may include an audio and/or visual notification.

Alternatively, in the event that the service procedure requirements are satisfied, the roof maintenance system may issue a roof certification. The roof certification may be published in one of several embodiments. For example, the publishing step may include preserving an unalterable copy of the roof certificate in the database. Supplemental information may only be associated with the unalterable copy of the roof certification in the database and may not otherwise change the contents of the roof certification. In an alternative embodiment, the publishing step may include printing the roof certification certificate in a gazette, a public notice section of a newspaper or otherwise filing or registering the roof certification with a local regulatory authority. After registration, the structure owner may transfer ownership of the roof certification. In this regard, roof certification records are maintained in a similar manner as title records are maintained with respective properties. The roof certification owner is, accordingly, informed by telephone call, a text message, an email, or an automatically generated letter that the roof certification is about to expire or has already expired. At this point, the structure owner has the option to re-certify the roof in accordance with the roof maintenance system disclosed herein.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic illustrating communication throughout the roof maintenance system;

FIG. 2 is a flow chart illustrating steps for performing a maintenance request with a local or remote software application;

FIG. 3 is a flow chart illustrating an inspection process for assessing the condition of a roof;

FIG. 4 is a flow chart illustrating the steps for repairing a roof structure for compliance with roof certification standards;

FIG. 5 is a flow chart illustrating the steps for finalizing and publishing a roof certification;

FIG. 6 is a flow chart illustrating the steps for ascertaining the proximate cause of a roof leak;

FIG. 7 is a flow chart illustrating steps for repairing a roof leak caused by an Act of God;

FIG. 8 is a flow chart illustrating the steps for repairing a roof leak caused by a third party or another non-insurance covered cause; and

FIG. 9 is a flow chart illustrating the steps for repairing a roof leak caused by normal wear and tear.

### DETAILED DESCRIPTION OF THE PREFERRED EMBODIMENTS

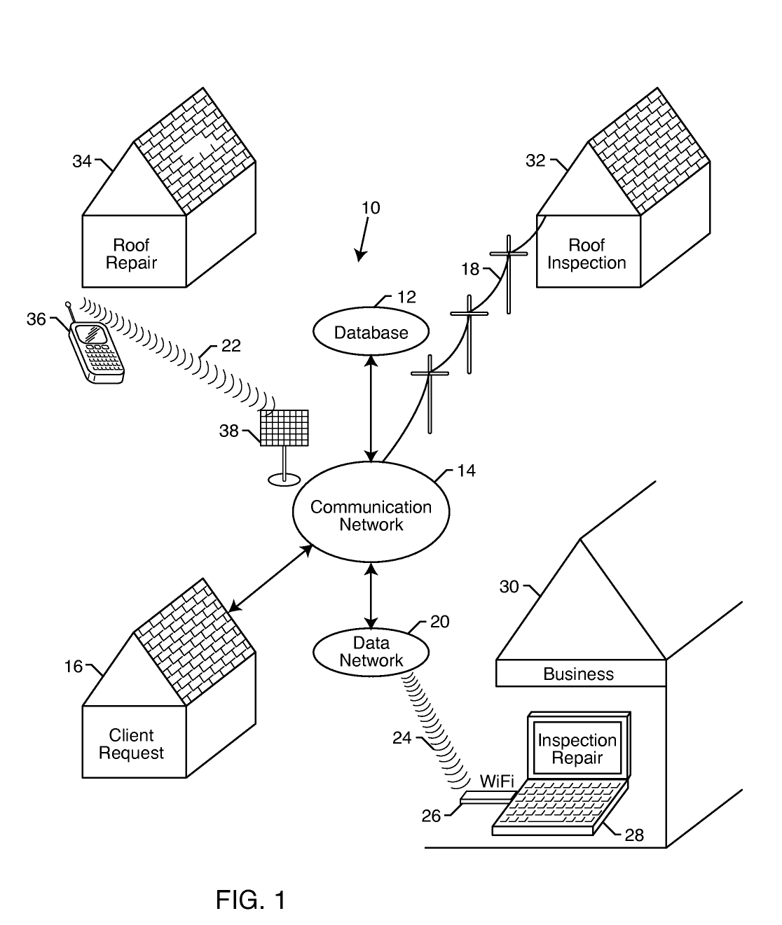

As shown in the drawings for purposes of illustration, the present invention for systems and processes for maintaining a roof is generally referred to by the reference number 10. In FIG. 1, the roof maintenance system 10 includes a database 12 that uses a communication network 14 to communicate with clients and contractors. The database 12 may include a stand-alone computer system or a series of network computer systems or servers that contain a plurality of information relating to the accounts of the properties served by the roof maintenance system 10. The database 12 is preferably located offsite in a remote, yet secure location, while simultaneously being in continuous communication with the communication network 14. Data may be transferred between the database 12 and the communication network 14 by any means known in the art, such as through the Internet, through telephone lines or data networks. The database 12 is integral to the roof maintenance system 10 and should always be “online”—meaning that clients and contractors may communicate with the database 12 through the communication network 14 at any time. The purpose of the communication network 14 is to provide a central hub for receiving and disseminating information within the roof maintenance system 10. This generally includes receiving and properly routing client requests to contractors capable of providing the maintenance necessary to otherwise inspect, certify or repair the roof of the client. The roof maintenance system 10 ensures that roof maintenance meets minimum certification requirements established in the trade.

In general, a software application, whether run locally as a stand-along application on a computer system or otherwise accessible remotely via the Internet through an internet-enabled web browser, provides control over the inspection, certification and repair processes. The synchronization of the software application with the database 12 ensures consistency within the roof maintenance system 10. The software application may assist an inspector, a contractor or other professional in the trade during the processes of inspection, repair, certification, certification administration, call back, warranty repair work, submitting insurance claims, etc. The software application is also integral to lead handling, scheduling, repair, and warranty administration. Access to certain sections of the software application may be restricted to those contractors having completed relevant training for each process, including inspection, certification and/or repair. Notably, the software application requires contractors to follow a specific protocol or procedure in a sequence that ensures compliance with minimum certification standards established in the trade. Preferably, the contractor is required to meet enhanced roof maintenance requirements. In this regard, the software application has built-in control mechanisms that manage workflow and require performance compliance. For example, before an inspection section can be completed, a contractor must answer questions that enable the software application to ascertain whether the contractor inspected the roof in accordance with set standards. In fact, roof certifications cannot issue without software application-driver assurance that any inspection, certification or repairs meet these minimum safety and warranty standards. As a result, the gains in efficiency, reporting detail, work-sharing and call back handling allow contractors, inspectors, etc. to provide higher quality service while spending much less time on note entry, photo management, report preparation, reporting, proposal preparation and scheduling.

As shown in to FIG. 1, the communication network 14 may receive a client request 16, such as an inspection, certification or repair request. The client request 16 generally originates from a homeowner, a realtor, a seller, a lender or an insurer. The communication network 14 routes the client request 16 to the database 12. The database 12 is configured to receive and handle the client request 16. In this regard, the database 12 determines how to appropriately route the client request 16 within the roof maintenance system 10. Where the client request 16 is routed and how the routing is performed once received by the database 12 certainly depends on the origination and substance of a client request 16. For example, the client request 16 may originate as a telephone call from a homeowner endeavoring to obtain maintenance services on a roof structure. The database 12 routes the telephone call to an appropriate customer service representative or to a contractor capable of answering the questions of the client and scheduling an inspection, certification or repair of the roof. Alternatively, the client request 16 may originate as an electronic message (e.g. an email, an SMS message or a text message) requesting a quote to inspect a roof, a quote to repair a leaky roof or a quote to certify an existing roof structure. Such an electronic request may be generated through a data network, such as the Internet, and may involve submitting such information into a web page or other electronic document that the communication network 14 can route directly to the database 12. With the information at hand, the database 12 may forward the information to a customer service center to review the information submitted in the client request 16. The customer service representative may then notify a contractor who can discuss the details of the request with the client. In an alternative embodiment, the database 12 automatically analyzes the information received from the communication network 14 to automatically schedule or contact a contractor. The roof maintenance system 10 may also automatically contact the client by email, text message or an SMS message with a response to the client request 16. Here, the client may receive notification of a scheduled appointment with a contractor registered with the database 12 and capable of servicing the client request 16.

Routing the client request 16, i.e. lead handling, is an important aspect of the functionality of the roof maintenance system 10. Typically, leads are handled by the database 12 through the communication network 14. The database 12 includes territory information that defines contractor work area(s) relating to the various services offered by the roof maintenance system 10. The database 12 routes the client request 16 through the communication network 14 to the highest qualified contractor available to perform the client request 16. Routing may depend on several criteria, including the type of registration held by the contractor with the database 12. For example, leak inspections are preferably assigned to contractors that inspect and repair roofs. Naturally, such referrals also go to contractors that work on the type of roof pertaining to the client request 16. Leads are also preferably assigned based on geographic location where the contractor primarily does business, contractor willingness to take on additional jobs, and contractor reviews (e.g. contractors that have a solid track record of responding quickly to leads).

Ultimately, the lead assignment system integrated with the database 12 effectively disseminates leads to those highly-qualified contractors that are registered with the database 12 and have an in-depth knowledge of the type of services that need to be performed pursuant to the client request 16. This necessarily requires that contractors open an account and register with the database 12. Contractor account information may include name, address, license, applicable service area specialties and various registrations held with the database 12 to handle various client requests. This enables the database 12 to automatically and immediately assign the client request 16 and to notify the client via the communication network 14 of each newly assigned lead. The software application is also integral to a shared scheduling system set up and managed by in the database 12. In this regard, the software application, regardless of whether run locally or remotely, synchronizes with the database 12 to update contractor availability and the scheduling of client requests. This enables the database 12 to schedule an appointment pertaining to the client request 16 with a qualified contractor at a time convenient for the client and the contractor. This may occur even before a contractor is contacted with regard to the client request 16. Accordingly, the contractor may use the communication network 14 to contact the client to firm up the appointment automatically scheduled by the database 12. Automated lead assignment by the database 12 may also take into consideration the subscription level of each contractor and whether or not the contractor pays for exclusive leads generated by the roof maintenance system 10. Contractors that pay for exclusive leads are automatically billed for leads as assigned.

The scheduling system in the database 12 is also integral to lead assignment in the realm of conveying client and property information to the contractor around the time the client request 16 is scheduled with the contractor. For example, the scheduling system may associate information supplied by the client with information already stored in the database 12. The scheduling system may then send that information to the contractor before the contractor contacts the client or around the time the appointment is scheduled. Alternatively, the scheduling system may send the information at any stage during the fulfillment of the client request 16. The information retrieved in the database 12 by the scheduling system may include prior inspection reports, certification reports, repair reports and other jobs or service requests. Information in the database 12 also enables the scheduling system to identify whether any work had previously been performed at the client address. In this regard, a customer service representative or other automatic call receiving system may access the database 12 to view and verify the information provided by the client contacting the roof maintenance system 10. The information in the database 12 may immediately identify any prior contractors that may have previously worked on the roof. In a preferred embodiment, the scheduling system immediately identifies the client or client property and routes the client request 16 to a contractor that previously inspected, certified, repaired or otherwise warranted the roof.

Each contractor registered with the database 12 may create self-generated leads in the scheduling system. More specifically, a contractor may access the scheduling system in the database 12 with the aforementioned software application to enter work order requests received outside of the roof maintenance system 10. This requires that the software application synchronize with the database 12 to ensure proper routing of future client requests 16 based on the availability of the contractor. Contractors may also schedule appointments for other contractors registered with the database 12. For example, a contractor inspecting a roof, but not qualified to repair the roof, may generate a lead from the roof inspection site for a repair contractor, at the conclusion of the inspection. In this regard, the inspection contractor may share the lead that developed as a result of roof inspection and/or roof certification. This scenario typically occurs when the inspection contractor determines that the roof requires repair to meet certification standards. Since the inspection contractor is not registered with the system 10 to do repair work, the inspection contractor may refer the work to another contractor registered with the system 10 to perform the maintenance repairs. Accordingly, the repair contractor receiving the lead may be charged a lead fee. The inspecting contractor may immediately access the schedule of the repair contractor through the software application in order to immediately schedule an appointment with the client. Of course, the repair contractor is notified by, e.g., email, text message, SMS message, phone call, etc., of the newly scheduled work order registered with the scheduling system in the database 12. The repair contractor may also be notified of the newly scheduled project through synchronization of the software program with the database 12.

Self-assigned leads may only be entered and self-assigned to the contractor pending the lead has not already been entered into the scheduling system in the database 12. A lead is already entered when, for example, a request for the same service at the same property is already in the scheduling system in the database 12. Self-assigning leads entered into the scheduling system in the database 12 are particularly preferable for contractors because the contractor can track self-generated business along with lead assignments from the roof maintenance system 10. Accordingly, the scheduling system of the database 12 synchronizes with the software application locally or remotely accessed by the contractor, preferably in real-time, to keep the contractor up to date as to any current or future work to be performed.

Only those contractors registered with the database 12 may obtain leads therefrom. In one aspect, a local “administrator” may define the area or territory assigned to a particular contractor, or a set of contractors, capable of performing certain services within a particular service district. Contractors registered within a certain territory are generally given priority to leads, depending on the criteria for assigning leads with the territory. In a preferred embodiment, the territories are divided into three sections: (1) a standard territory; (2) an extended territory; and (3) a service territory. The standard territory is the geographic area where the contractor is located for regular lead assignment rotation. This is the general territory that any contractor receives as an introductory membership to the roof maintenance system 10. The contractor may receive exclusive leads in the standard territory. The extended territory includes a larger geographic area in which the contractor is willing to consider leads, if no other contractor with an encompassing standard territory is available. Additionally, a contractor may register in a service territory that includes a defined geographic area where the contractor is willing to provide specific services. For example, a contract might be willing to provide standard services such as roof repair in a ten-mile radius, while willing to provide cool roof coatings, a specialized service for flat roofs, within a fifty-mile radius. Territory assignment is preferably automatically designated to certain contractors based on membership in the database 12, but may otherwise be independently assigned by the local administrator. The local administrator is primarily responsible for overseeing a specific territory, such as handling contractor disputes and miscellaneous requests the roof maintenance system 10 cannot otherwise automatically handle. The local administrator may also be a contractor and can retain standard, extended or service territories accordingly.

Additionally, a general administrator of the roof maintenance system 10 may govern the overall operation and assignment of service districts. To local administrators. Preferably, general administrators do not have territories at all. Alternatively, the aforementioned local administrators may maintain territories, maintain a contractor directory of territories, govern the issuance of standard, extended and service territories, and regulate self-assignment of leads, in a service district established by the general administrator. The general administrator preferably also regulates local administrators that are also contractors, estimators, inspectors, etc.

One key aspect of efficiently routing the client request 16 to the most capable and qualified contractor is to define geographic areas based on the most efficient and cost effective distribution of contractors in an area. In this regard, the roof maintenance system 10 identifies and assigns certain geographic areas to contractors capable of performing particular services. This enables the database 12 to automatically field and route client contacts for successful execution of the workflow process. Additional contractors capable of performing client requests may be trained and deployed within a geographic area as needed. In one embodiment, the standard territory and the extended territory may be designated to a contractor within a ten-mile radius and a fifty-mile radius, respectively, from the principal place of business of the contractor. The service territory is more specific to particular geographic areas and preferably does not include a default service area radius as does the standard and extended territories. The default standard territory and extended territory radii may be altered or modified by the local administrator according to the geographic area where the contractor operates. For example, contractors may be assigned by zip code defining the primary address of the contractor. This may be changed, for example, when the contractor has an office in one county, but performs the majority, if not all, business in a different county. It is common in the trade for contractors to have an office with trucks and supplies in one industrial area while the base of the business is performed in a suburban area that is primarily residential and located at a distance away from the industrial office. Alternatively, the radius of the extended territory may be designated as “none”—meaning the contractor is unwilling to consider leads outside of the standard territory. Moreover, the default territory setting may also be replaced by a list of states, counties, cities and/or zip codes within which the contractor is willing to perform general or specific services. Transportation infrastructure, topography and demographics frequently result in differently shaped territories. A person of ordinary skill in the art will readily recognize that the territories may be designated, assigned and categorized by any method known in the art.

Leads can otherwise be generally entered by contractors, customer service representatives or other personnel registered with the roof maintenance system 10. Customer service representatives and/or contractors may access a software application intended to assist in entering a lead into the database 12. The software application requires entry of certain information (e.g. roof type, age, location, etc.) in order to find the best possible matching contractor(s) in the database 12. This naturally requires obtaining sufficient information from the client in order to find a contractor capable of making a highly-qualified return call to the client regarding the requested services. Preferably, the client request 16 originates electronically through submission of a web-based form submitted directly by the client through the Internet. Of course, the web-based form cannot be submitted without providing the requisite information. Alternatively, the client request 16 may originate as a phone call handled by a customer service representative trained to obtain the requisite information from the client. Here, the customer service representative may enter the information into a computer for automatic handling by the database 12. The objective of such an electronic lead entry form is to obtain enough information from the client to schedule an appointment or otherwise contact a contractor that can call the client back or adequately perform the services requested in the client request 16.

In another aspect of the roof maintenance system 10, the database 12 may automatically populate a list of contractors registered with the system 10 that may have previously performed services for a client submitting the client request 16. This pre-populated list of contractors is created so the request can be routed to the contractor that was previously assigned the services. The database 12 preferably populates this list of contractors as soon as the client enters a name, zip code, or address where the work will be performed. If the roof was previously certified, the certification number alone may be used. The pre-populated list of contractors may include a plurality of information about the contractors, the services previously performed by the contractors, the standing of the contractors with the roof maintenance system 10, coverage area, etc. For example, the list may note whether a contractor is in good standing with the system 10. The local administrator may flag contractors that are not in good standing with the roof maintenance system 10 based on, for example, non-payment of lead fees, expired registrations, failure to take ongoing training, poor performance, unsatisfied client base, etc. Other information on the contractor may include coverage area (e.g. standard territory, extended territory, service territory), designation of exclusive or non-exclusive leads, designation as the next recipient of a lead (e.g. denoted by a flag set by the local administrator), the most recent date the contractor received a standard territory lead, or a lead shortage (i.e. the number of leads per month desired by the contractor minus the number of standard territory lead fees charged to the contractor). Of particular note, the local administrator has some ability to steer leads with flags in order to keep multiple contractors within a particular territory satisfied. Moreover, leads that do not count toward the aforementioned shortage include call backs, specific requests for a particular contractor, self-generated leads and assignments outside of the standard territory.

One type of lead includes repeat business. Repeat business is generally categorized as a request for a new service, other than a call back, that either pertains to a previously serviced property by a contractor registered with the database 12 or is from a client that has done business with the roof maintenance system 10 in the past. Once the client is identified by property, zip code, etc., the client may be asked for general details regarding prior experiences with the roof maintenance system 10. This enables the database 12 to identify the client or the property. In one embodiment, the client may request a contractor by name or registration number and the database 12 accordingly assigns the lead to the identified contractor. If the requested contractor is unlisted, then the roof maintenance system 10 may endeavor to locate the contractor by obtaining more information from the client. If the desired contractor is still not found or is otherwise not registered with the database 12, the lead may be automatically reassigned or sent to the local administrator for handling. Preferably, the roof maintenance system 10 exhausts all options for finding the contractor, especially when a contractor previously provided services at the client address. Such a search for the prior contractor may be bypassed when the contractor is not on the list of potential assignees, the caller explicitly indicates the desire to use a different contractor or the caller asks for a different contractor by name. Information regarding the client and the service history of a property associated with the client is immediately accessible via information in the database 12. Thus, it should be immediately known whether another contractor previously performed any services at an address matching the client request 16. When a contractor is assigned a lead from repeat business as a referral, the contractor is charged a lead fee.

Lead fee rates may be charged to each contractor individually, assigned to a group of contractors within a particular territory, or charged by some other contractor-identified algorithm. Preferably, the lead fee is an amount the contractor agrees to pay to the roof maintenance system 10 for each lead received therefrom. The lead fee may be a flat fee per lead, a tiered fee based on the quantity of leads provided per month, a percentage of the client bill, or based on some other criteria. Preferably, the lead fee is debited from a contractor account in the database 12 immediately upon acceptance of the lead by the contractor. Contractors may be required to maintain a balance with the database 12 or provide other debit or credit information. The roof maintenance system 10 may also be designed to charge the contractor a lead fee when the contractor refuses a lead from a client. Moreover, the contractor may also be charged a lead fee when the lead returns unprocessed, especially when the lead is in the standard territory of the contractor and the scheduling system determines that the contractor is available to take the lead.

Contractors assigned a lead are preferably immediately notified via text message, email, etc., as described above. Additionally, the lead is added to the lead list of the contractor through the scheduling system so the contractor can access the details of the lead through the software application. In one embodiment, a text message of a lead includes the ability for the contractor to reply to the scheduling system in order to accept or decline the lead. Alternatively, an email notification preferably includes links to the scheduling system to indicate acceptance or refusal of the lead in a similar manner. Text message and email replies both preferably include some means to indicate the time of the anticipated appointment, if one is scheduled. In this regard, the software application is particularly useful as contractors can use it to work remotely. The software application enables the contractor to indicate acceptance or refusal of appointment times remotely from various locations (e.g. job sites, businesses or from home) having access to the communication network 14. Lead refusals may be reassigned via the database 12 or otherwise sent to the local administrator. If a contractor does not indicate either acceptance or refusal of the lead within twenty-four hours, the roof maintenance system 10 assumes the lead is unprocessed and automatically reassigns the lead and notifies the local administrator of the failure of the contractor to respond to the lead.

Leads that are not otherwise applicable to any one of the aforementioned sections are considered new business. Contractors are typically charged a lead fee for any lead designated as new business. Accordingly, new business resulting from such a lead means that the client making the client request 16 does not have an account in the database 12. In this event, a client account is created in the database 12 and contact information stored therein. Additionally, information such as the type of building, roof type and/or number of stories of the structure should also be entered into the client account. This information may be manually entered by a customer service representative or otherwise submitted electronically by email or via a web page on the Internet. Categories of requisite information may be pre-populated and accessible through drop-down menus or otherwise manually enterable by the client into a form field on the web page. Drop-down menus or pre-populated categories are preferred such that the roof maintenance system 10 can appropriately automatically locate a contractor capable of servicing the client request 16. Accordingly, the list of potential contractors capable of servicing the client is filtered by comparing the information in the client account to each contractor profile. In one embodiment, the database 12 generates a list of contractors and the client selects the desired contractor to perform the requisite services. Alternatively, the lead from the client is automatically routed, as described in detail herein.

Any one of a variety of communication means known in the art may be used to facilitate the communication between and among the database 12, the client request 16 and the contractors associated with the roof maintenance system 10. As shown in FIG. 1, such communication may be across a plain old telephone service (POTS) 18, through a data network 20, or over a cellular network 22. The POTS network 18 is specifically designed to facilitate voice communications over a landline telephone or other VoIP voice or data network. The client may communicate directly with a live-customer service representative over the POTS network 18, may communicate with a voice recognition software program that steps the client through any one of a plurality of menus capable of facilitating the client request 16, or may utilize a menu selection system integrated for use with a touch tone telephone. A person of ordinary skill in the art will readily recognize that the POTS network 18 may be used to facilitate any one of a number of communications through the communication network 14 in association with the database 12.

Similarly, the communication network 14 may make use of the data network 20 or the cellular network 22 to communicate information in and among the roof maintenance system 10. For example, the data network 20 may include WiFi networks, DSL networks, ADSL networks, T1 lines, FiOS data communication networks, cable or other internet or data networks capable of transferring information between the communication network 14 and the software application. With respect to FIG. 1, the data network 20 communicates over a wireless network 24 to a WiFi adapter 26 in a computer 28. The computer 28 in FIG. 1 is a portable laptop that may be moved from location to location. For example, a contractor may transport the computer 28 from a business location 30 to a roof inspection location 32, to a roof repair location 34, etc. The wireless network 24 may be replaced by any other data communication network known in the art capable of exchanging information with the data network 20 and the communication network 14. For example, the computer 28 may connect to the data network 20 through a dial-up modem, a cable Internet connection, a DSL or ADSL line, a T1 line, a cellular data network, or other Ethernet or wireless (e.g. WiFi) network. The key aspect here is that the contractor owning or leasing the computer 28 has a means for communicating with the database 12 at a variety of locations, including the business location 30 and on-site locations such as the roof inspection location 32 or the roof repair location 34.

Moreover, a person of ordinary skill in the art will readily recognize that the computer 28 may be replaced by any one of a number of different technologies capable of portable communication with the communication network 14. For example, FIG. 1 further illustrates use of a cell phone 36 through the cellular network 22 with a cell tower 38. Of course, the cell tower 38 links to the communication network 14 for access to the database 12. In this embodiment, the cell phone 36 may comprise any cell phone known in the art, including smart phones, Blackberry's and other portable electronic devices capable of communicating over the cellular network 22. In one embodiment, the cell phone 36 performs similar functionalities as a telephone call through the POTS network 18, as described above. In another embodiment, the cell phone 36 facilitates web-based and/or data communication with the communication network 14 that may be otherwise unavailable through use of a landline telephone. Both the computer 28 and the cell phone 36 may include a stand-alone software application capable of accessing the database 12. In this regard, the software application may be installed on a desktop or laptop computer from a purchased compact disc (CD), digital versatile disc (DVD) or a file downloaded from the Internet. Here, the software application runs locally on the computer system. A similar application may be downloaded and installed on the cell phone 36. For example, a contractor may download an “APP” from Apple Inc. of 1 Infinite Loop, Lupertino, Calif. 95014 for use on the Apple iphone. Alternvatively, the software application may be an internet-enabled web browser that accesses the database 12 through the communication network 14. Thus, the software application is capable of facilitating roof maintenance in accordance with the embodiments disclosed herein.

Of course, the cell phone 36 may be used similarly to the computer 28 such that the contractor can receive alerts, client requests 16 and other information remotely at maintenance sites or business locations. This enhances the ability of the contractor to schedule maintenance requests and to obtain information regarding the job site before actually arriving on site to facilitate the service request. The communication devices, whether a landline telephone, the computer 28 or the cell phone 36, must be able to synchronize with the database 12 through the communication network 14 to ensure uniform and accurate roof maintenance servicing according to industry standards. The roof maintenance system 10 disclosed herein ensures such compliance.

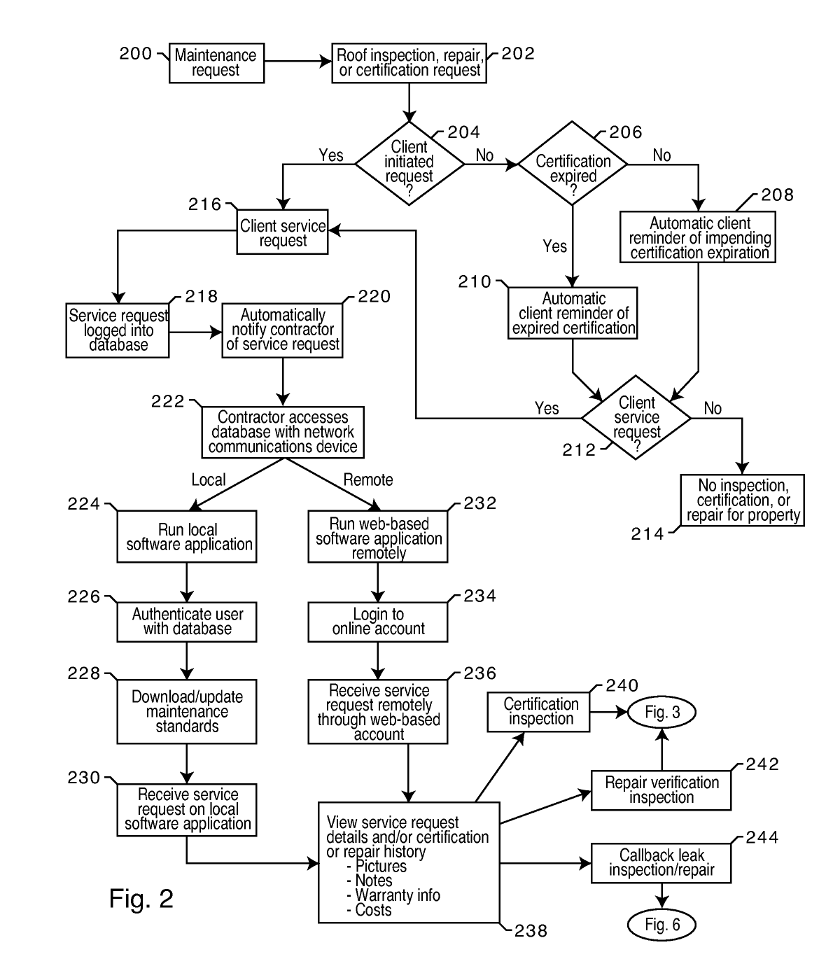

FIG. 2 is a flow chart illustrating a process for handling a maintenance request (200). The maintenance request may include a roof inspection request, a repair request, or a certification request (202). Such a maintenance request may encompass inspection, certification or repair of a roof under a variety of different conditions. In a particularly preferred embodiment, the maintenance request pertains to leaks. But, the maintenance request may also pertain to a variety of other conditions that include mold proofing, verifying that the roof structure is sound, etc. Such a request (202) may originate as the client request 16 (FIG. 1). Alternatively, the request may be automatically generated by the database 12 and communicated to the client through the communication network 14. In this regard, it must be determined whether the client initiated the request (204). Non-client initiated requests typically occur with existing clients having accounts in the database 12. Client accounts are typically created in the database 12 based on a prior maintenance request, including a roof inspection, roof repair or roof certification. Detailed contact and property information is stored in the client account in the database 12 so the roof maintenance system 10 may communicate directly with the client. This feature is particularly useful to automatically remind the client of beneficial roof maintenance checkups. Before contacting an existing client, it is first determined whether the client has an expired certification (206). One feature of the roof maintenance system 10 is automatic notification in the event a certification is about to expire or has otherwise expired. Centralizing maintenance information in the database 12 by client property makes it easier to inform clients of expiring certifications or expired certifications. The status of the roof may certainly have an affect on the quality and maintenance of the roof over the long-term. Information acquired during a certification inspection, as described in more detail below, may be sent to the client with the certification as part of a periodic roof report. An automatic client reminder of impending roof certification expiration (208) is sent to the client via any of the aforementioned communication means, if the roof certification has not expired. Such a reminder may include information regarding the prior held certification, the duration of the certification, any repairs or maintenance performed to certify the roof, pictures or other contractor notations recorded during certification or repairs performed during the certification period. In a similar sense, even if the certification is expired (206), the database 12 may generate an automatic client reminder of the expired certification (210) to inform the client that it is time to re-certify the roof. The database 12 may send the client updated inspection/certification materials detailing any new certification requirements or building codes that may affect the property. A copy of the automatic client reminder of impending certification expiration (208) or the automatic client reminder of expired certification (210) is saved in the client account in the database 12.

Next, it must be determined whether the client makes a service request (212). The automatic reminders (208), (210) may enable the client to communicate with the database 12 through any one of the plurality of communication means described with respect to FIG. 1. For example, the automatic reminders (208), (210) may include a telephone call to the client such that the client may make the service request by pressing a button to speak with a customer service representative. In an alternative embodiment, the automatic client reminders (208), (210) originate by email, text message or SMS message, and the client may electronically respond. For example, the automatic client reminder (208), (210) may be sent to the client via email such that the client may accept or decline electronically. More specifically, the email may include a link to schedule an appointment or a link to decline re-certification. No maintenance request is scheduled and no inspection, certification or repair for the roof (214) is conducted when the client declines the service request. Declining the service request or otherwise failing to respond to either one of the client reminders (208), (210) is noted in the client account in the database 12. Further automatic reminders may be periodically sent to the client of impending certification expiration or actual certification expiration. The client has the option of declining further communications from the database 12 with regard to maintaining the roof. The client may also accept or decline roof maintenance through use of an automated system over the telephone or electronically via a text message or an SMS message service. Acceptance means the client makes a client service request (216).

The client service request (216) may be handled manually, such as through a telephone conversation with a customer service representative, or automatically through an electronic submission. In the former embodiment, the client service request (216) is fielded by a customer service representative having access to the database 12. The customer service representative receives information from the client according to the desired maintenance request. Information provided by the client may vary depending upon whether the property is to be inspected, certified or repaired and whether the certification period has expired. In the latter embodiment, the client may access a web-based software application, such as a web-portal accessible through any major internet browser (e.g. Internet Explorer, Firefox, Opera, Safari, etc.), to fill out a form effectuating the client service request (216). Of course, the service request is logged in the database (218) and documented in association with the client account. Such information will be available at a later date in the event of a call back or a request to reschedule. Contractors registered with the roof maintenance system 10 have access to the service request logged in the database (218) in order to effectuate the service client request (216). The client may request scheduling of an appointment at the time of speaking with the customer service representative or otherwise filling out the web-based form. The information inputted into the database 12, either by the customer service representative or by the client, is compared with a list of contractor accounts to determine the availability of a contractor capable of handling the client service request (216). Preferably, available contractors registered to perform the services requested in the client request, and within a cost effective distance from the property location (e.g. within the standard territory), are given priority to the lead.

The database 12 also includes a plurality of contractor accounts searchable by location, registration, etc. With respect to the roof maintenance system 10, a contractor is any entity capable of inspecting, repairing, certifying a roof, or otherwise qualified to perform other roof-related services. Accordingly, the contractor may have a state license to inspect, repair or certify a roof. Moreover, the contractor may be qualified, certified, registered or licensed in multiple roof repair-related areas. Contractors registered with the database 12 are given priority to effectuate a maintenance request through the roof maintenance system 10. Selection of a contractor to perform the desired service request, in the event that more than one contractor is available to schedule an appointment during the time requested by the client, may be chosen according to any number of criteria. For example, automatic assignment of a lead may follow rules such as: (a) if the lead is for an unidentified service type (e.g. “other”), the lead is assigned to the local administrator; (b) from among the contractors capable of performing the request within the standard territory, those contractors having a lead shortfall (i.e. one wherein the number of leads per month desired by the contractor is less than the number of lead fees charged to the contractor) are given priority, followed by the contractor having gone the longest time without receiving a lead (e.g. through use of an assignment flag, which is cleared once the contractor receives the lead), and assignment to a contractor that qualifies within the extended territory and that is non-exclusive; (c) for multiple contractors qualifying within extended territory coverage, the order follows section (b); or (d) if the lead cannot be automatically assigned by the system, the local administrator for the territory manually assigns the lead. The lead may otherwise be immediately assigned to the local administrator in the event a contractor is not automatically matched with the client or the client requests to speak directly with such a representative. Contractors preferably have up to two hours to refuse a lead and, if not accepted within a twenty-four hour period, the lead is redistributed to another contractor. In an alternative embodiment, an unaccepted lead or an ignored lead is transferred to the local administrator for reassignment. The local administrator may then screen a list of potential contractors based on some or all of the aforementioned considerations.

The local administrators are generally responsible for facilitating a set of designated territories. Local administrators are generally notified via text message and/or email of leads that are not immediately assignable, call backs that cannot be referred to the contractor that issued the certification or warranty (or otherwise provided past services), referrals that request contractors that are either not available or no longer a registered member, or leads that are refused or unprocessed. Leads sent to the local administrator preferably include an indication as to why the lead is on the list and the time in which the lead was first received. Other information on the list may include identification of any contractors having been involved with the lead and the status of the lead, i.e. accepted, refused, unprocessed or open. Accordingly, the local administrator must be able to search for the lead in the database 12 with the software application, preferably through the web-based portal, to look up the contents of the lead and to filter, or otherwise “unfilter”, any combination of contractors by member area, roof type, building type, number of floors and/or services offered. The local administrator then selects one or more contractors capable of performing the requested services. The list preferably includes links to contractor profiles in the database 12 or other external web page where the local administrator may access the details of the contractor, such as registrations with the database 12, inspection, certification or repair history, satisfaction ratings, etc. These features make it easier for the local administrator to contact contractors with the potential lead. Service requests that cannot be filled require the local administrator to either flag the lead as declined and notify the client that the services cannot be performed, or refer the lead to someone else not registered with the system 10. A notation that the lead was referred to a non-registered contractor is placed in the client account.

Lead handling of the client service request (216) is preferably handled electronically and automatically by the database 12 through the communication network 14. In a preferred embodiment, the database 12 includes a lead assignment system that automatically and quickly assigns the client service request (216) by directly contacting a contractor. Responding to the client service request (216) in this regard is preferably faster than competitors. The lead assignment system immediately routes the client service request (216) to a contractor in a geographic area capable of handling the client service request logged into the database (218). Preferably, the lead assignment system in the database 12 generates an electronic message that immediately contacts a contractor via either the computer 28 (e.g. email, instant message, etc.) or the cell phone (e.g. a telephone call, text message, SMS message, etc.). The contractor may receive the account information of the client, including any new information provided by the client at the time of making the client service request (216). At this point, the contractor knows the account history associated with the client and the type of service request. This enables the contractor to more accurately and quickly respond to the client service request (216). Accordingly, the contractor may accept, decline or otherwise schedule a meeting with the client by communicating back to the lead assignment system in the database 12 via the communication network 14. In one embodiment, the contractor schedules an appointment with the client and the client is notified accordingly by an automatically generated telephone call, email, text message, etc. Automatically notifying the contractor of the service request (220) is more efficient, whereby clients experience higher quality administrative service in conjunction with inspection, certification and repair of roofs in less time than coordinating through other systems known in the art.

The contractor may access the database 12 with a network-enabled communication device (222) to acquire more information on the property of the client requesting the service. Compiling maintenance information within the database 12 for each client property improves the quality and speed of service by allowing the same data to support a variety of reporting and archiving needs during the lifespan of the client roof. In this respect, the database 12 serves as a storehouse for data gathered on a property, regardless of the number of maintenance requests (i.e. inspections, certifications, repairs, etc.). Information is time-stamped and marked to identify contractors that gathered the information filed in the client account. Sometimes, more than one maintenance request is performed on a property during the lifespan of a particular roof. By accessing the database 12 with a network-enabled communication device (222), the contractor has access to a wealth of information regarding the service history of the roof for existing clients.

The roof maintenance system 10 provides two main mechanisms for accessing the database 12. First, the contractor may run a local stand-alone software application (224). The local software application may be used in conjunction with the computer 28 and may communicate with the database 12 through the communication network 14 via the data network 20 over the wireless network 24. In this embodiment, the contractor may communicate with the database 12 from the business location of the contractor or from a maintenance site. The portability of the computer 28 provides more flexibility and enables continued communication with the contractor, especially when the contractor is out of the office. The contractor must authenticate with the database (226) to gain access therein. The contractor may be required to input a user name and/or password to access the database 12. This feature further ensures quality and preservation of information within the database 12 to registered contractors. Contractors may be organized in the database 12 by geographic location, registration, license, etc. The database 12 also provides enhanced quality control mechanisms. For example, contractors that perform poorly or otherwise lose or fail to renew a state issued inspection or repair license are denied membership to the roof maintenance system 10. Moreover, contractors with unsatisfactory performance may be suspended or permanently blocked from accessing the database 12. Contractors in good standing are granted access to the database 12 and may view or print information gathered about the client property and the service request logged in the database (218). The authenticated contractor may need to download and/or update the maintenance standards (228) corresponding to the service request logged in the database (218) on the stand-alone computer before performing the maintenance request. Requiring synchronization of the maintenance standards (228) ensures that the contractor receives updated information in the local software application to ensure compliance with any new rules or regulations that govern the inspection, certification and/or repair of a roof. The software application, whether run locally or remotely, generally governs the maintenance service request to ensure the highest quality standards are met. Information logged by the software application during the maintenance request is transferred to the database 12 and may be later referenced in the event of a call back.

Moreover, the contractor may receive additional service requests through the local software application (230) when synchronizing with the database 12 via the communication network 14. The contractor may receive the service request locally on site or at another location having access to the database 12 through the communication network 14. The software application provides forms for quick and easy gathering of pre-maintenance information. Included in the information received in the service request (232) is information related to the type of client roof and a list of potential materials that may be needed to inspect, certify or otherwise repair the roof. Of course, the type and amount of information either gathered by the contractor or received through the software application (230) will vary from job-to-job and from contractor-to-contractor.

Second, the contractor may remotely access the database 12 with a network-enabled communication device (222). This is accomplished by running a web-based software application remotely (232). The web-based software application is preferably accessible via any internet-enabled electronic device, such as a computer, cell phone or other portable communication device, such as a PDA. Nowadays, most portable electronic devices include some type of internet-accessible software application capable of browsing information on the Internet. In this regard, the data network 20 and the cellular network 22 are particularly preferred for use with the computer 28 and the cell phone 36, respectively. The contractor must first log into the online account (234) in the database 12. From there, the contractor can read the details of the service request remotely through the web-based account (236). In this embodiment, the contractor has direct access to the database 12 through the communication network 14. The contractor is not otherwise required to download and/or update the software application, as required in step (228) when running the local software application (224). Rather, all updates to operating procedures, such as inspection, certification and repair procedures, are updated automatically in the database 12 for eventual remote access by the contractor with the web-based software application. Remote access to the database 12 is particularly preferred as it involves less transfer of information from the database 12 to the local software application. In this regard, the database 12 only needs to transfer data through the communication network 14 to enable the contractor to view the relevant maintenance documentation, such as service history, maintenance procedures, etc. Rather than downloading the information, the information remains securely stored in the database 12 and is otherwise incapable of being transferred or copied from one computer to another. Essentially, the information is in a read-only format when accessed by the contractor through the web-based software application. Only those contractors having accounts in the database 12 are capable of logging into the online account (234). The security associated with logging into the online account (234) is preferably some form of encryption or a secure socket layer (SSL) to ensure that information in the database 12 remains secure and otherwise generally non-accessible by the public.

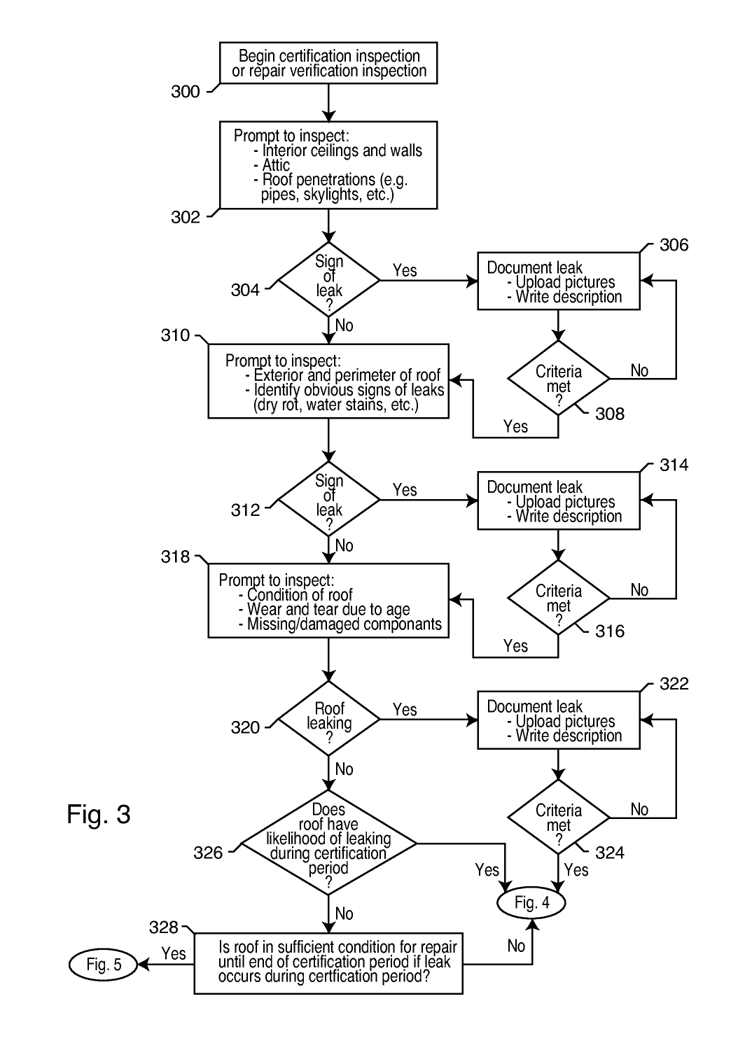

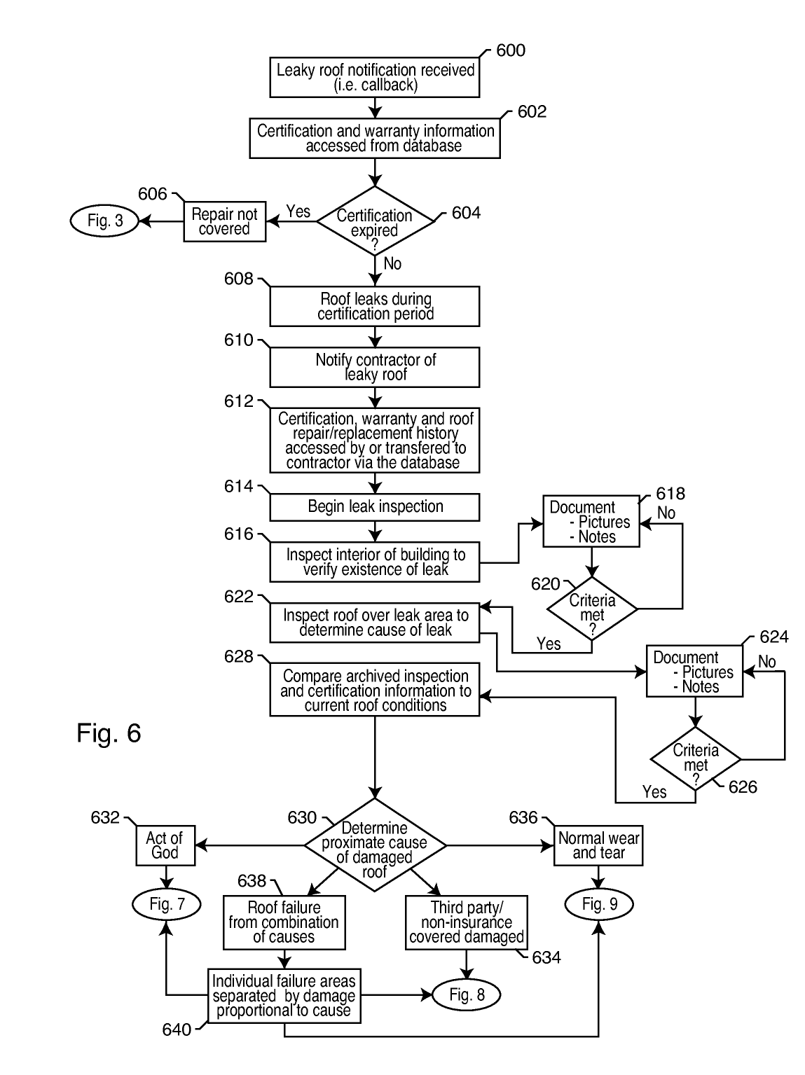

After either step (230) or step (236), the contractor may view the details of the service request, certification history or repair history within the client account (238). If the client previously received certification for the roof structure, the contractor has immediate access to the certification information and/or any repair history associated with placing the roof in a condition to be certified. The contractor may also view other service requests conducted during the certification period that may have required roof repair. Detailed information is stored in the database 12 such as roof pictures, inspector notes, repair pictures and notes, repair estimates, and costs associated with inspecting, certifying and/or repairing the roof. Such information accessible by the contractor provides a colorful history of the roof and enables the contractor to better diagnose current problem areas associated with an inspection, certification or repair, especially to stop the roof from leaking. The contractor then performs either a certification inspection (240) or a repair verification inspection (242), which are illustrated in more detail with respect to the flow chart in FIG. 3, or a call back leak inspection/repair (244), which is illustrated in more detail with respect to the flow chart in FIG. 6.

FIG. 3 illustrates a flow chart for conducting a certification inspection and/or a repair verification inspection (300). The inspection process is typically conducted by an inspector or other contractor having inspection credentials registered with the database 12. The inspecting contractor registered with the database 12 is different than “home inspectors” known in the art because “home inspectors” traditionally do not usually inspect the roof. The certification inspection and/or repair verification inspection (300) must be used in conjunction with the software application that is run either locally or remotely, as described above. The contractor uses the inspection software to note observations and file associated photographs. The inspection process itself is organized by section and is specific to the type of roof. The certification inspection and/or roof verification inspection (300) is designed to find and repair roof problems and to provide a road map that may be later used to handle call backs on certified and/or warranted roofs. The software application is so designed to at least meet minimum maintenance requirements in the industry. Of course, these requirements may change over time and the software application is updated accordingly through the communication network 14 and the database 12. More specifically, the inspection is normally broken down into sections that include the interior structure, the attic, a garage (if applicable), the perimeter of the structure, the exterior of the structure and the roof. The software application may also prompt the inspector to take two photographs of the front of the property for purposes of identification.

In a preferred embodiment, the software application prompts the contractor to first inspect the interior ceilings and walls (e.g. drywall, plaster, wood, etc.), the attic and any roof penetrations (e.g. pipes, vents, heater flue, HVAC ducts and piping, chimneys, skylights, etc.) (302). Furthermore, inspecting the attic may require use of a flashlight to properly inspect the roof framing (e.g. rafters, ceiling joints, ridge beams, valley rafters and beams, etc.), sheathing (e.g. solid plywood, solid wood boards, spaced sheathing with plywood thereover, spaced sheathing with felt, etc.), and other roof framing materials such as wood shingles. The contractor notes the condition of the interior ceilings and walls, the attic and the roof penetrations during the inspection. The contractor records notes with the application software regarding the condition of the inspected sections, the materials comprising the sections and any potential problems observed. These findings are recorded as observations with the software application and are necessary to complete the maintenance request.

The software application prompts the contractor to determine whether there is a sign of a leak (304). The contractor must document the leak (306) in the event that there is a sign of a leak. Documenting the leak (306) involves recording the symptoms, causes and remedies for fixing the leak. These factors, of course, depend on the type of roof. For example, inspecting the interior of the property, the attic or the garage (finished or unfinished) may reveal water stains or dry-rot. The contractor may use a moisture meter or a thermography camera, in addition to noting the location and taking photographs of these observations, to properly document and flag these problems. Moreover, the contractor may observe felt deterioration, felt sagging between sheathing boards or sheathing that has spaces with no felt. With respect to wood shingles, problems such as being able to see the tile roof or light shining through the roof into the attic or observable problems that are documented. The contractor must take pictures of the affected roof structure, write a description of the current condition and note other observations regarding the condition of the roof structure, especially conditions that may affect the status of any existing certification or potential certification. The uploaded pictures and written description are stored in the software application and eventually transferred via the communication network 14 to the database 12 for storage with the client account. The recorded information may be used at a later date in the event of a call back or re-certification inspection.

The compiled information is used to create a customized observation outline to be used in association with an estimate and repair work order. The observations recorded as part of documenting the leak (306) are useful to show the client the necessary repairs (if any) to adequately fix the leak and otherwise bring the roof into certification standards. The software application verifies whether the criteria for documenting the leak (306) has been met (308). If the contractor has not satisfactorily documented a leak (306), the software application does not allow the contractor to move to the second inspection stage. In this regard, the inspector is prompted by the software application to continue documenting the leak (306) in order to properly and adequately diagnose the maintenance request. The software application preferably prompts the contractor to enter the missing information in order to move on.

Once the desired criteria of step (306) is met (308), the contractor is prompted to inspect the exterior perimeter of the roof and to identify obvious signs of leaks (e.g. dry rot, water stains, etc.) (310). Perimeter sections requiring inspection may include eaves, soffits, fascia, rake boards, rafter tails and gutters. Exterior walls such as stucco, wood siding or brick/stone must also be inspected and noted with the software application. The contractor must again determine if there are any signs of a leak (312) in the aforementioned exterior or perimeter sections. For example, water stains and/or dry-rot in the perimeter or exterior of the roof may be signs of a potential leak. The contractor may red flag these problems, take photographs and note the location of these problems. Particularly with respect to the exterior perimeter of the roof, roof eaves are examined for obvious signs of water leakage, such as dry rot, water stains, mold, etc. In the event of a sign of a leak (312), the contractor again must document the leak (314) by taking pictures with a digital flash camera and recording an adequate description describing the condition and location of the leak in the perimeter or exterior of the roof. The contractor may take as many pictures as necessary to adequately record and document the roof condition. Use of the digital flash camera is ideally used in conjunction with the computer 28 such that the contractor may upload the pictures directly into the local software application onsite. In an alternative embodiment, the contractor may take the pictures directly with the cell phone 36, or other similar device, and immediately send the pictures to the database 12 through use of the software application or other picture messaging service.

The software application again analyzes the information submitted during the document leak step (314) to determine whether the criteria has been met (316). Of course, the criteria may vary from project-to-project depending on the type of roof, the local or federal rules and regulations governing the inspection, certification and/or repair of the roof and/or any other applicable standards applicable to the maintenance request. Use of the software application is particularly desirable because it ensures that each contractor maintains conformity to the local and state laws and other regulations that govern the servicing of maintenance requests. If the criteria is not met (316), the software application requires the contractor to further document the leak (314). The contractor is not allowed to move on to the next step without first satisfying all criteria (316), as described above. Once the criteria is met (316), the software application prompts the contractor to inspect the overall condition of the roof for normal and/or abnormal wear and tear due to age (318). The contractor should note conditions such as missing and/or damaged components of the roof that otherwise might cause the roof to leak.

Roofs generally fall into two categories: (1) low slope roofs; and (2) steep slope roofs. Low sloped roofs include weatherproof membranes while steep sloped roofs include water-shedding roof coverings. Slopes less than fourteen degrees generally define a low sloped roof, while anything above fourteen degrees encompasses steep sloped roofs. With respect to low sloped roofs, the contractor normally needs to inspect built-up roofs having a cap sheet surface or a rock sheet surface. The contractor may also need to inspect parapet walls or flashings. The flashings may include pipes, valleys, step flashings, roof-to-wall flashings, chimney flashings (including chimney crickets and chimney saddles), HVAC flashings, roof vents, parapet flashings, counter flashings, pitch pans, edge metal and skylight flashings. Moreover, with respect to the pipes, the contractor should note the conditions of the sealant around the pipe flashing and the condition of the pipe flashing around the top of the roof membrane. Of particular importance here is to note the absence of sealant, cracked sealant or flashing that rusted through the sealant. Moreover, exposed nails and the absence of sealant or cracked sealant around pipe flashing on top of the roof membrane is a particular problem that needs to be red flagged.

Alternatively, steep sloped roofs require other general inspection considerations. For example, the software application may require the contractor to upload pictures illustrating all faces of the structure in the event the contractor is unable to get on the roof. Moreover, the software application may require the contractor to determine the number of layers of the roof, whether the contractor used binoculars, telescopes or other magnification technology to view and inspect the roof, or whether the contractor used a pitch meter to determine if the roof has the proper amount of slope to drain water for the roofing materials. In general, steep sloped roofs may include materials such as composition (e.g. 3-tab, lightweight or heavyweight dimensional), wood (e.g. shingles or shakes), tile (e.g. flat concrete/synthetic tile, S-tile, 2-piece top and bottom tile, etc.), or metal (e.g. corrugated, stone coated steel or standing seam). The software application red flags any of the aforementioned roofs that are installed on a roof pitch of less than fourteen degrees when measured by the pitch meter. Of course, such notation will require repair to bring the roof within a certifiable condition. Flashings, such as pipe, valley, step flashings, roof-to-wall flashings, chimney flashings (e.g. chimney cricket and saddle), roof vents, parapet flashings, counter flashings, pitch pans and edge metal should also be inspected in accordance with the steep sloped roof.

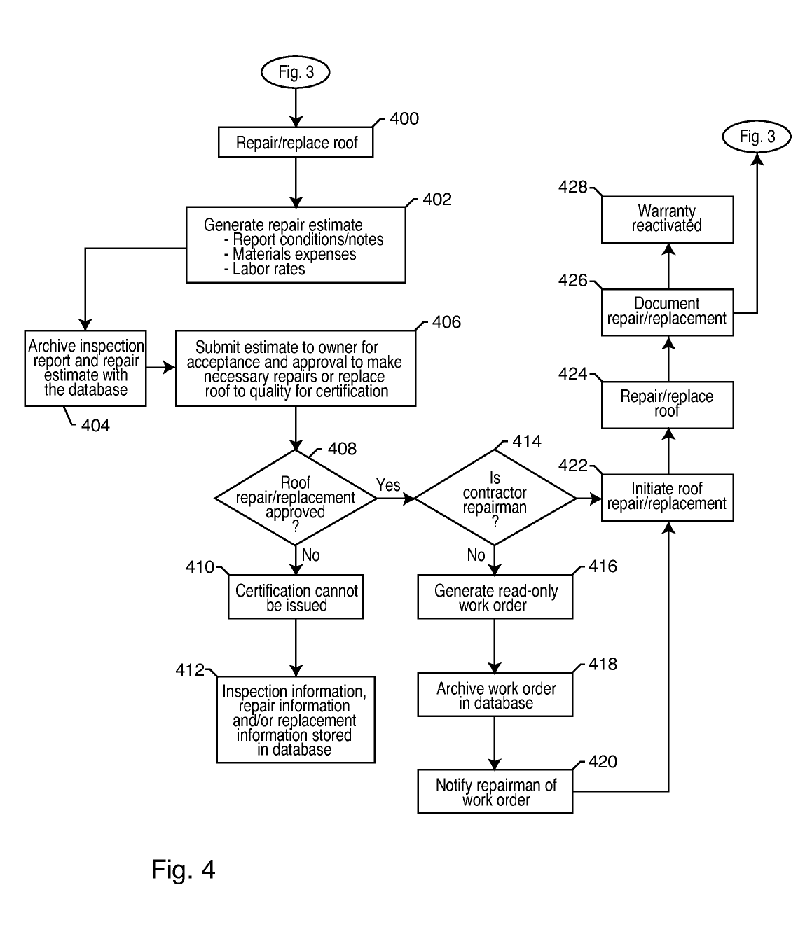

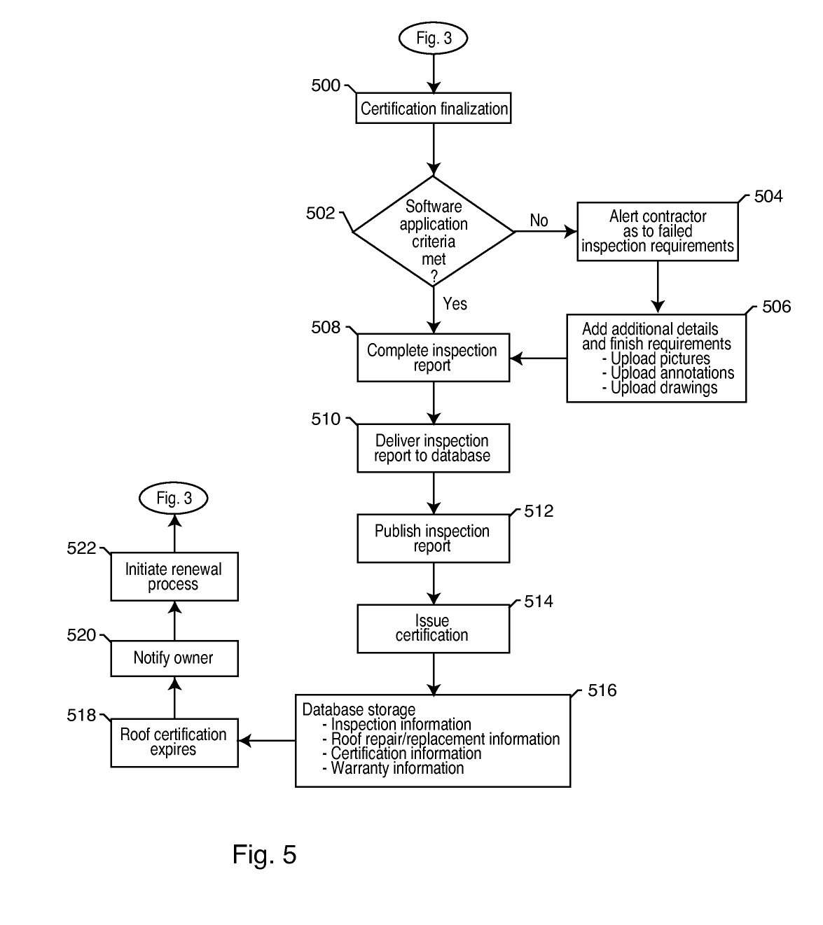

Preferably, the software application requires the contractor to note, for each inspected section, whether the roof would meet or fail certain certification criteria for that particular roof. Ultimately, as a result of the inspection steps (302), (310), (318), the contractor should determine whether the roof is leaking (320). This is an important determination as the certification or repair of the roof necessarily depends on the result of determining whether the roof is leaking (320). If the roof is leaking (320), the contractor is required to document the leak (322) by uploading pictures and writing an adequate description that provides enough detail that can be used in a corresponding repair estimate and work order to repair the roof. The documentation can later be used as a reference tool in the event of a call back or re-certification request. The contractor may only continue on to generate a repair estimate, as described in more detail with respect to FIG. 4, once the software application determines that the criteria is met (324). Alternatively, if it is determined that the roof is not leaking, the contractor must decide if the roof has a likelihood of leaking during the certification period (326). In the even that the contractor determines that the roof has a likelihood of leaking during the certification period or if the contractor determines the roof is in insufficient condition for repair to not leak until the end of the certification period, the contractor must prepare a repair estimate in accordance with FIG. 4. Otherwise, the contractor proceeds with finalizing the certification, as described in more detail with respect to FIG. 5 below.

FIG. 4 is a flow chart illustrating steps for repairing and/or replacing a damaged roof (400) that is leaky or otherwise does not comply with current certification standards. The information gathered and inputted into the software application in steps (302), (310), (318) may be used by the contractor to show the client the type of work that needs to be completed in order to repair the roof to receive a certification. Such a report for use by the client can be automatically generated by the database 12 or the associated software application and sent to the client electronically. The first step is to generate a repair estimate (402) based on the information collected during the inspection process described with respect to FIG. 3. The repair estimate (402) reports to the client the conditions and/or notes recorded during the inspection process, the materials expenses that will probably be associated with repairing the roof and any relevant local labor rates for performing the repair. The software application automatically includes a glossary of relevant terms specific to the inspection when the form report is produced. In one embodiment, the contractor may use the software application to generate a formal inspection report for the entire roof. Note that the contractor cannot create this report if the inspection is incomplete, as described above. The contractor may be alerted by the software application as to any missing information and the software application may require the contractor to complete the inspection before the report is produced. Common reasons for failing to satisfy the inspection requirements may include failure to upload pictures, failure to complete a section (e.g. answering all questions therein), providing a “Does Not Meet” answer to one or more questions in a section, failing to indicate that one or more observations satisfies or fails certification criteria, or failing to complete any required pre-inspection information.

The corresponding inspection report and repair estimate preferably prepares the estimated summary of repair in one of three methods: (1) An observation entry form where the contractor can note the price associated with the remedy. Each quoted price is presented as a line item in the estimated summary of the repairs along with the remedy for fixing the roof. (2) The software application estimates the cost of the repair. The software application is set up in advance to include standard charges and mark-ups as dictated nationally or by local contractors. (3) The estimate of repairs are produced via direct manual entry into a template provided by the software application or the database 12. The contractor can optionally note the price associated with any repair via manual line entry in the repair proposal.

Furthermore, the generated repair estimate (402) may include a disclosure statement as required by state or federal regulation in the geographic area wherein the client property resides. These mandatory and/or optional disclosures are automatically attached to the report. This aspect of the roof maintenance system 10 is particularly important as updates to these laws and regulations are automatically made to the database 12 by the general or local administrator and dispersed through the communication network 14 to the local software applications before a contractor can inspect a roof. Similarly, the database 12 maintains an updated list of these rules and regulations such that a contractor using the remote web-base software application automatically receives these disclosure statements at the end of the inspection process. Once complete, the software application immediately archives the inspection report and repair estimate with the database (404) to preserve an unalterable copy as documentation of what was delivered to the client. Of course, the inspection report and repair estimate may be later retrieved by registered contractors that endeavor to further maintain, inspect, repair or otherwise certify the roof in the future.

The next step is to submit the estimate to the client (406) for approval to make the necessary repairs and/or replace the roof to qualify for certification. The client must decide whether to approve the repair and/or replacement of the roof (408). In the event that the client declines approval, a roof certification cannot be issued (410). Accordingly, the inspection information, repair and/or replacement information along with the refusal to grant permission to repair the roof are then transferred to the database 12 and stored in the client account. All of this information may be later accessed in the event of a client request 16 that requires a maintenance request (200) or other certification inspection and/or repair verification inspection (300).

In an alternative embodiment, not all inspection information must be entered at the time the inspection is performed. In fact, the contractor may find it desirable to access the inspection data after returning to an office or other business location 30, as shown in FIG. 1. The inspection data may be stored and transported locally on the computer 28 or otherwise stored remotely in the database 12. The contractor may later access the information in the database 12 through any of the communication means described above to finish the inspection report. This is particularly desirable as the contractor may work away from the inspection site. This prevents the contractor from spending unnecessary additional time at the inspection site. The contractor may upload, modify or draw pictures that correlate to digital photographs taken onsite, annotate noted observations, “word-smith” the text to identify symptoms, causes and remedies for specific observations, clarify the report or presentation, and/or enter overall notes for incorporation into the report. All of this inspection information, repair information and/or roof replacement information is stored in the database (412).

In the event that the client approves the roof repair and/or replacement (408), the software application determines whether the contractor is simply an inspector or a repairman (414) capable of performing the required repairs and/or replacement of the roof to bring the roof within the certification standards. In this respect, the software application may automatically verify the contractor's credentials during the authentication step (226) or the login step (234). If the contractor is not also a registered repairman, the software application automatically generates a read-only work order (416) for storage and retrieval in the database 12. The repair work order contains other relevant details of the inspection, including any notes or photographs uploaded by the contractor into the software application and stored in the database 12 via the communication network 14. Preferably, the software application archives a read-only copy of the repair work order in the database (418) for later accessibility by other contractors, repairmen or inspectors registered with the roof maintenance system 10 the archive serves as documented proof of services rendered if the client challenges the quote or misunderstandings arise regarding the inspection or work order. Limiting the accessibility of the work order to read-only status enhances the security associated with the roof maintenance system 10 and ensures the accuracy of reports and estimates provided to clients after completion of inspections. Preferably, only members registered with the roof maintenance system 10 have access to this information.

Once the work order is archived (418), the database 12 automatically generates a message to notify a registered repair contractor of the work order (420). This may occur according to any of the aforementioned communication means, including those described and shown with respect to FIG. 1. Preferably, the notification (420) is automatic and may be integrated with the aforementioned scheduling system. The scheduling system may be based in the database 12 or be based on a portable software application that synchronizes with the database 12. The scheduling system communicates with the repair contractors registered with the roof maintenance system 10 via the software application, or other portable communication device such as a cell phone. This is particularly preferable as the database 12 may automatically schedule appointments with repair contractors to perform the desired work order. Repair contractors have the option of noting times of availability or unavailability depending on the individual schedules of the contractors. The client also has the option of hiring a separate repair contractor, but this obviously requires obtaining additional estimates and would otherwise delay the repair work of the roof to stop a leak and bring the roof to within certification standards. A third party repair contractor may be granted read-only access to the inspection data upon registering with the database 12 or otherwise paying a fee to access the information. There may be other methods built into the database 12 to enable parties not registered with the roof maintenance system 10 to view inspections, repair summary estimates and/or the standards for bringing the roof to within certification standards. But, third party contractors cannot issue roof certifications or warranty work through the roof maintenance system 10. Such services can only be issued by registered contractors.

The repair contractor initiates roof repair and/or replacement (422) by reviewing the inspection report and repair work order. The initiating step (422) may occur on site if the contractor is the repairman (414) or off site in the event that the repairman is notified of the work order (420) at a different location. The repair contractor proceeds to repair and/or replace the roof (424). Of course, during this procedure the repair contractor is also required to document the repair and/or replacement of the roof (426). The documentation step (426) is similar to the documentation steps (306), (314), (322) described above with respect to FIG. 3. In this case, the repair contractor notes the fixes to the identified problems. The repair contractor may also need to provide a diagram of the roof (i.e. roof plan) and indicate on the diagram the area(s) damaged and repaired. Additionally, the repair contractor should add any necessary notations and/or drawings to note the repaired areas and the process, materials and labor required to fix those areas. The repair contractor preferably enters the resolution for each repair and uploads pictures illustrating the roof after the repairs are complete. This is important so as to provide the requisite documentation (426) of the work performed on the roof, especially if the roof is under warranty. Even if the roof is not under warranty, this information is still important for any potential roof certification that may issue as part of the certification inspection and/or repair verification inspection (300). Such notations are beneficial to an inspector certifying the roof and can also be useful in the event of a call back for a leaky roof or other damage that may have occurred in association with the repair (424) during the warranty period. Once the repair and/or replacement of the roof is properly documented (426), the warranty is reactivated (428) if the repair and/or replacement of the roof (424) occurred during the warranty period. Otherwise, the fixed roof may need to be inspected in accordance with FIG. 3, as described above, to obtain a roof certification.

Depending on the type of inspection or repair service, indication by the software application that the repair is complete activates the warranty (428) or otherwise makes the property eligible for certification in accordance with the flow chart of FIG. 3. The purpose of documenting the repair and/or replacement (426) is to create a service history that may be used to diagnose and fix problems. To complete the documentation step (426), the repair contractor must indicate that repairs are complete by uploading repair pictures, noting observation resolutions and providing an electronic signature that the repair satisfies the relevant local certification standards. The software application will not allow the work order to close out until the repair is complete and properly documented (426). Alternatively, when the repair contractor is not a member of the roof maintenance system 10, a contractor registered with the system 10 must perform a repair verification inspection (300) and make the inspection entries that would otherwise have been made by the repair contractor if the repair contractor were a member of the system 10. Using an unregistered third party may, consequentially, increase the cost of obtaining a certification by requiring duplication of work that would otherwise be performed by trained professionals registered with the system 10.

FIG. 5 is a flow chart illustrating the continuation of roof certification from FIG. 3. More specifically, FIG. 5 illustrates the steps for roof certification finalization (500). The software application facilitates and governs the issuance of a roof certification after the inspection process is complete through communication with the database 12 via the communication network 14. In this regard, only trained contractors have access to the software application, as described above, to ensure that the resultant certification meets certain minimal requirements set in the industry. Upon moving into the certification finalization step (500), the software application first determines whether all criteria for issuing a certification have been met (502). The software application alerts the contractor as to any failed inspection requirements (504) and otherwise prevents the contractor from issuing a roof certification. The alert may be audible and/or visual and integrated into the software application. The alert may identify specific fields missing information required to issue the roof certification. Alternatively, the software application may notify the contractor of missing information at a later date, such as after submission of the certification request to the database 12. In this embodiment, the certification may be first reviewed manually by quality control representatives having access to the database 12 to ensure compliance. Accordingly, the contractor may need to add additional details and finish the requirements (506), such as uploading pictures or drawings, notes, etc. to satisfy the software application certification inspection standards (502). Most commonly, software application certification inspection criteria is unsatisfied (502) due to failing to upload pictures, failing to complete a section by answering all questions posed by the software application, providing a “Does Not Meet” answer to one or more questions in a section, failing to indicate that one or more observations meet or do not meet certification criteria, or failing to complete any required pre-inspection information.

Once the software application criteria is met (502), the software application compiles and generates an inspection report (508). Onsite, the inspection report may be initially available as a read-only electronic document or may be printed to a hard copy for the client to immediately review. Alternatively, the inspection report may be compiled and generated (508) off site and sent as a read-only electronic document to the database 12 for storage. The document may subsequently be sent to the client electronically through the aforementioned communication network 14 or mailed to the client as a printed hard copy. The database 12 notes the contractor submitting the inspection report and any contractor that completed any repair services so the database 12 has a complete history of those responsible for inspecting and certifying the roof in the event of any liability due to a call back during the warranty period. In some cases, the contractor performing the certification or repair work on the roof may be responsible for fixing a subsequent leak that occurs during the warranty period due to poor workmanship. The database 12 also assigns a unique serial number to the inspection report and places a read-only copy into an archive. This information is also accessible later on in the event of a call back. Roof certifications are searchable by serial number, registered holder, property address, etc. The roof maintenance system 10 can also be used to transfer the registered holder of the roof certification to a new entity, such as a person purchasing a home. In effect, the system 10 maintains certification information in a manner similar to records associated with property titles. This is also particularly useful when the inspection is ordered by a home seller and transferred to the new home owner when the sale closes escrow. The database 12 is also set up to receive requests through the communication network 14 for additional copies of the roof certification. In the above example, lenders and agents may want to acquire copies of the certification in addition to those provided by the registered owner to verify the authenticity of the certificate. In this regard, the database 12 may manually or automatically manage the distribution of certificates through any of the aforementioned communication means. In a particularly preferred embodiment, the database 12 receives an electronic submission through an internet web page or other software application in communication therewith to automatically respond to the electronic submission with a similar read-only electronic copy of the certification. Alternatively, a hard copy may be mailed to the requester for a fee. Moreover, the system administrator of the roof maintenance system 10 may require an entity requesting certification information to pay a fee in order for the system 10 to release a hard copy or an electronic copy of any information associated with the client account. The request for the certification may be logged in the database 12 and associated with the client account for future reference.

Before the certification can issue, the inspection report must be published (512). Publishing the inspection report (512) is the act of storing an archived copy of the report, at the time the report was produced, with the roof maintenance system 10. Publishing (512) serves several purposes. Notably, publishing (512) reduces record-keeping requirements of the contractor. Publishing (512) further protects against liability of the contractor and against any false claims by providing a record of the disclosures delivered to the client or other third party at the time of the inspection. Any subsequent alterations—whether changes to existing content or from a follow up inspection—are recorded as annotations to the original inspection report such that the original content in the report is preserved. An existing report cannot otherwise be altered. Such a report can only be re-published as a revision with the annotations. Publishing the inspection report (512) also provides a detailed report of the actual condition of the roof at the time the certification or warranty issued. The published report should also include an archived record of any repair work that was required to bring the roof into certification standards. Accordingly, the publication of the inspection report (512) is denied if any necessary information is not provided, as described above with respect to steps (502)-(506). Also included as part of the publishing step (512) is the ability of the contractor to use an optional glossary of terms in the report in lieu of the notes of the contractor. In this aspect, the software application includes a pre-populated dictionary of roofing definitions having standardized terms that may be selected by the contractor for use in the report. This certainly relieves the contractor of the burden of conforming the observation entries to standard industry jargon while simultaneously eliminating the use buzz words, acronyms, etc. that may confuse a client or another person reading the inspection report. A disclosure statement required by the regulations or laws in a designated geographic area of the inspection report are also published and automatically attached to the report. The contents of the disclosure statement depend on the type of report, the recipient and when the inspection report is published (512).

Once all of the inspection criteria are satisfied as described in steps (500)-(512) above, the database 12 issues a certification (514). The duration of the certification may vary depending on the factual circumstances surrounding the certified roof. The issued certification (514) is stored in the database (516) along with any relevant inspection information, roof repair and/or replacement information, other prior certification information or prior warranty information. The issued certification (514) may be published in a gazette or as part of a public notice in a newspaper or website. The database 12 may send an electronic copy or mail an official certificate of the certification to the owner of the structure. Certification issuance (514) may also involve sending the certification to a local or state government agency or other building regulatory authority. These filings may be required by local, state or federal law. Certifications nationwide will, of course, vary depending on the local and/or state laws. Certifications will also inevitably vary by warranty duration and damage coverage based on the location where the certification took place. Repair costs, including deductibles, covered by the certification may be supplemented by public or private insurance, or may be paid, in whole or in part, by a third party—depending on the proximate cause of the damage to the roof during the warranty period. At some point the roof certification expires (518) and the database 12 generates an automatic message to notify the owner (520) of such expiration or impending expiration to initiate the renewal process (522). Such notification may follow steps (206)-(212), as described above with respect to FIG. 2. Of course, any changes to the inspection standards between the date of certification and the renewal date are changed, managed and updated in the database 12 in association with the software application through the communication network 14.

FIGS. 6-9 are flow charts that further describe a process for repairing a leaky or damaged roof through use of the roof maintenance system 10. More specifically, FIG. 6 illustrates a flow chart for diagnosing a leaky roof notification received from a client (600)—i.e. a call back. The call back may originate through any of the communication means described herein, especially with respect to those embodiments in FIG. 1. Call backs are calls related to leaks on properties where a contractor performed services in the past. Call backs generally originate from clients that either have an active certification or repair warranty or otherwise do not have an active certification or warranty in force (e.g. expired or never issued), but have had work done by a contractor registered with the roof maintenance system 10 in the past. Furthermore, scheduling and conducting call backs are also generally facilitated using the aforementioned embodiments. The call back may receive a higher priority, in terms of scheduling, when the client indicates, either over the telephone or through a web-based submission, that the roof is leaking. According to the above-described steps, the contractor contacted is capable of diagnosing the particular problem that may be causing the leak and may provide an estimate to the client for repairing the roof to within certification standards. With respect to the leaky roof notification received (600), the certification and warranty information in the database (602) is first accessed to verify the existence of the warranty and to determine the identity of the certification holder. This is accomplished through use of the aforementioned software application via either local or remote access.

In a particularly preferred embodiment, the certification or warranty information in the database 12 is immediately accessible. The client account is identifiable via a warranty number or a roof certification serial number. The client account may also be identified by positively identifying a contractor that previously performed work on the property or by identifying the property address. Accordingly, address information may be used to find prior certification information. From this information, the roof maintenance system 10 should be able to positively identify the client or the property, unless no work had been previously done on the property by a contractor of the roof maintenance system 10. Unassignable call backs are typically routed to the local administrator for resolution. Typical reasons that a call back might not be immediately assignable includes situations where the property is not in the database 12, the contractor is not known or otherwise identifiable, or the contractor is no longer in good standing with the system 10.

Upon finding the client account, the roof maintenance system 10 must first determine whether the certification has expired (604). In the event that the certification is expired, the repairs are not covered (606) and the client is, instead, directed to the steps associated with certification inspection or repair verification inspection (300) in order to have the roof repaired. Additionally, the client may be notified with a pre-written letter that the desired services are not covered but that the roof maintenance system 10 can otherwise perform the desired services.

In the event that the certification is not expired (604) and the roof leaks during the certification period (608), the contractor capable of fixing the roof is notified (610) using the above-described scheduling techniques. Preferably, the contacted contractor is one who previously performed services on the roof. With the notification (610), the contractor accesses the database 12 for roof repair and/or replacement history through local or remote use of the software application as described with respect to steps (224)-(236) in FIG. 2. The contractor may receive this information by accessing or transferring it to the contractor from the database (612). The contractor then uses the aforementioned software application to begin the leak inspection (614). First, the contractor inspects the interior of the building to verify the existence and source of the leak (616). The contractor documents (618) any relevant information by uploading pictures and adding notes to the software application regarding the leak. This may be accomplished by taking pictures of any water damage or otherwise noting a description of the area of the verified leak. Only if the criteria is met (620) by the software application, as described above, will the inspector be prompted to inspect the roof over the leak area to determine the cause of the leak (622). The software application may provide a systematic process for inspecting certain areas of a roof based on the type and location of the roof and any materials that comprise the roof. Again, the software application prompts the contractor to document (624) specific aspects of the roof area where the leak exists. Notably, the contractor may document (624) the leak with written notes and/or other pictures that adequately describe and detail the cause of the leak.

Only after the criteria is met (626) may the software application enable the contractor to compare any archived inspection and certification information to the current roof condition (628). In this step, the software application enables the contractor to observe the current and past conditions of the roof by accessing the database 12 over the relevant communication network 14. The comparison provides the contractor with an immediately observable report having a side-by-side comparison of the roof conditions at the time of certification and the current leaky conditions. This feature further enables the contractor to provide higher quality service while spending much less time performing off-site inspection efforts such as note entry, photo management, report preparation, communication and coordination. The inspection requirement steps (616), (622) associated with the software application requires that contractors follow a certain set of guidelines when inspecting and recording observations of a roof. This further enables the contractor to adequately document (618), (624) the observations to enable the software application to generate the comparison (628) of the archived roof condition to the current roof condition.

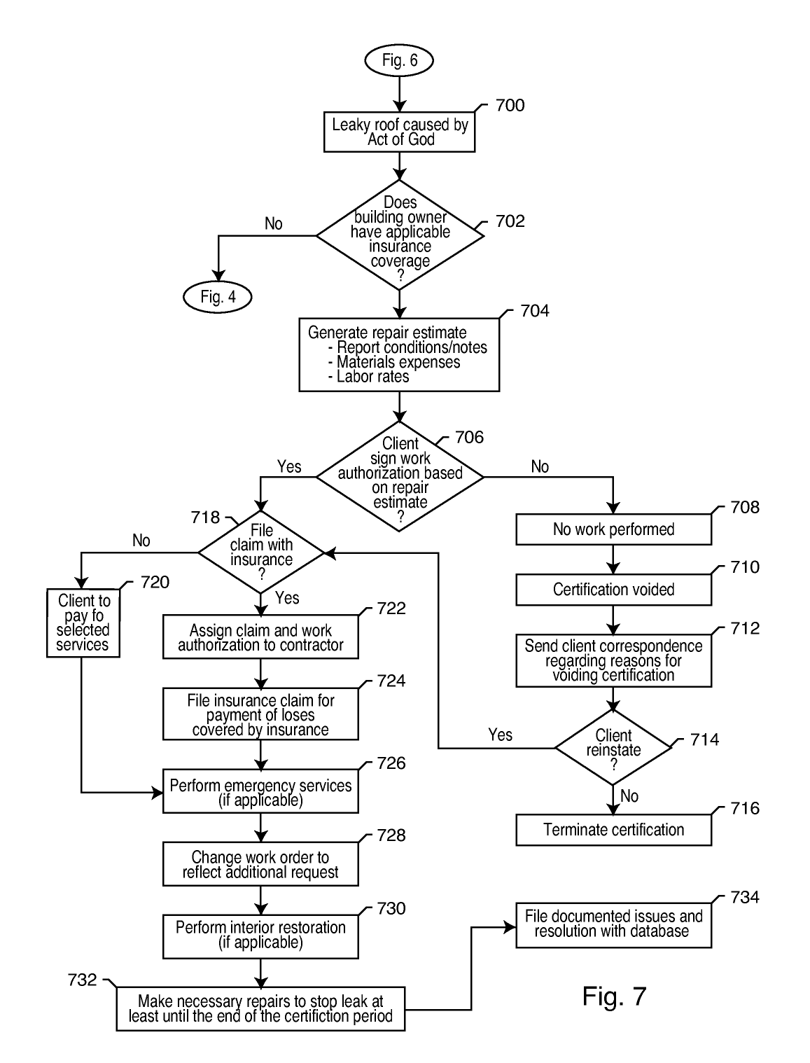

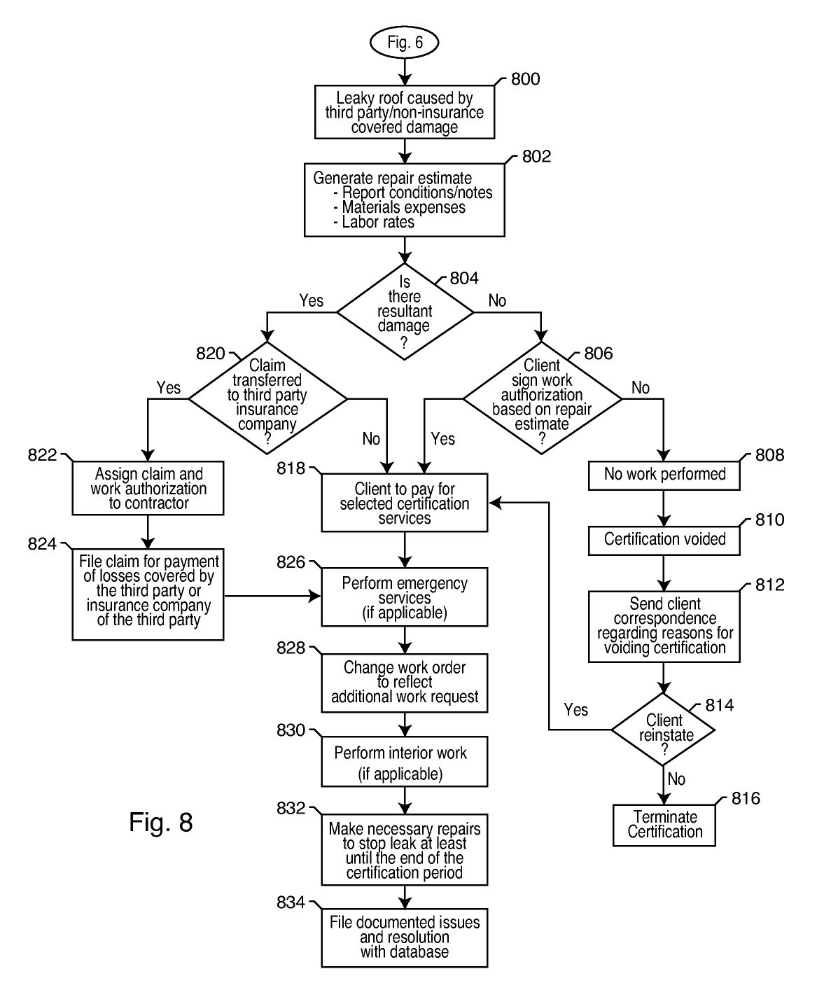

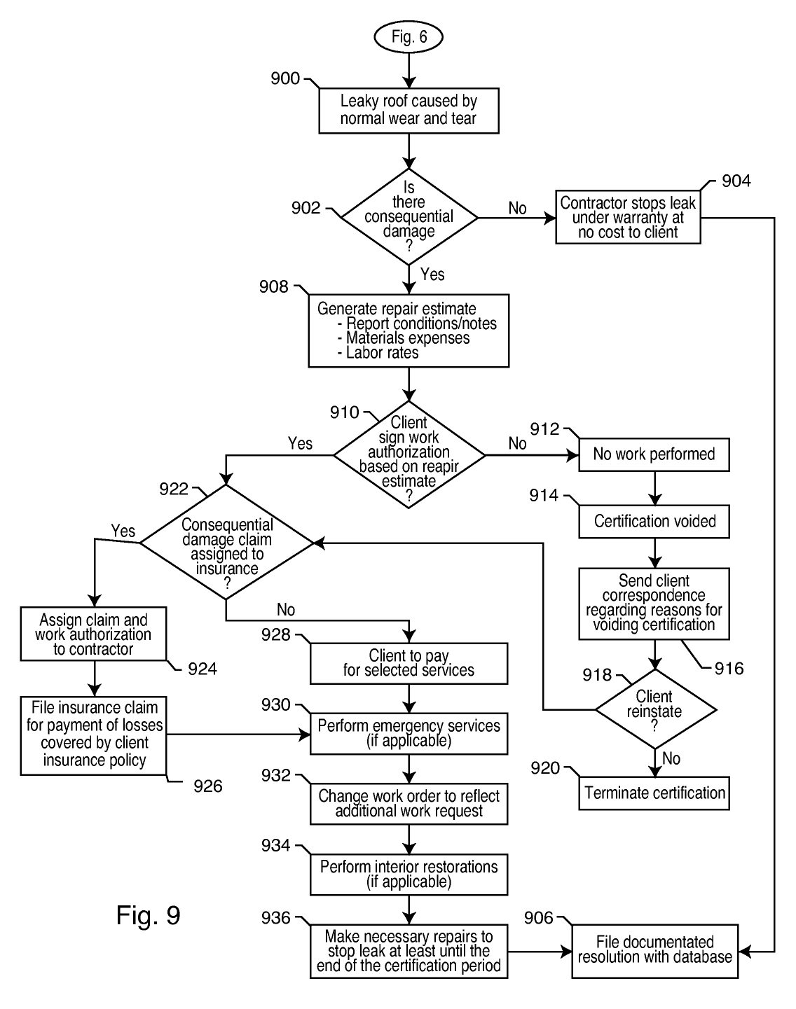

The contractor is trained as part of being registered with the roof maintenance system 10 to determine the proximate cause of the damaged roof (630) through use of the above-described comparison generated by the software application. In some instances, the proximate cause of the damage was caused by an Act of God (632), such as a thunderstorm, tornado, etc. Repairs of damage resulting from an Act of God are governed by the flow chart associated with FIG. 7. Alternatively, the proximate cause of the damaged roof may have been caused by a third party and/or by some other non-insurance covered source (634). The process for fixing this type of damage is discussed in more detail with respect to the flow chart in FIG. 8. Lastly, it may be determined that the proximate cause of the damage to the roof was due to normal wear and tear (636). Repairing this type of damage is described in more detail with respect to the flow chart in FIG. 9. Alternatively, the proximate cause of the roof failure may be from a combination of causes (638). For example, a thunderstorm damages the roof and an electrician repairing electrical problems caused by the thunderstorm causes further damage therein. Both the third party electrician and the homeowner's insurance policy may be required to pay for the losses. In such instances, the individual areas of failure are separated out proportionally by the amount of damage (640) depending on the proximate cause of the damage, as described with respect to FIGS. 7-9.

FIG. 7 is a flow chart illustrating the process for repairing a leaky roof caused by an Act of God (700). Here, the first step is to determine whether the building owner has applicable insurance coverage (702). If not, the repair and/or replacement of the roof is governed by step (400) with reference to FIG. 4. Otherwise, a repair estimate is generated (704) with the application software based on the information collected during the inspecting steps (616), (622) and the comparing step (628). The roof report may include a report as to the current conditions of roof, along with any notes, the past conditions documented during certification, material expenses and/or associated labor rates in the particular labor market. Accordingly, the client must sign a work authorization based on the repair estimate (706) before any work can be completed. In the event that the client refuses to sign a work authorization, no work is performed (708) and the certification is subsequently voided (710). The client's refusal to sign the work authorization is noted in the client account in the database (712) along with the voided certification. The database 12 then automatically generates correspondence to the client regarding the reasons for voiding the certification (712). This is important as the certification of the roof is dependent upon maintenance during the period that the certification is active. Failing to properly maintain and repair the roof can have an adverse impact on the expense of any future repairs. The costs for future repairs may not be covered due to a failure by the homeowner to maintain the certification. Thus, the roof maintenance system 10 may void the certification (710) in the event the client refuses to authorize the repair work.

The correspondence with the client can occur through any of the aforementioned communication means. Preferably, the client correspondence (712) is provided electronically such that the client is able to decide whether to reinstate the work authorization (714) automatically with the database 12. In this regard, the client may communicate with the database 12 through the communication network 14 by use of a comparable computer 28 or cell phone 36 having remote access to the web-based portal. In a particularly preferred embodiment, the client reinstates the work authorization by logging into the roof maintenance system 10, filling out an internet-based form and submitting the request electronically. The database 12 then routes the client request to a contractor in accordance with the above-described embodiments. In the event that the client fails to respond to the client correspondence (712) or otherwise declines to reinstate the work authorization, the certification is terminated (716). Such termination is noted accordingly in the client account in the database 12 to avoid future fraudulent claims in the event another contractor is called to perform inspection, certification or repair work. In this regard, the software application effectively prevents any contractor registered with the database 12 from performing inspection, certification or repair work without first accessing the client account with the software application.

In the event that the client signs the work authorization at either step (706) or step (714), it is next determined whether to file an insurance claim (718) for the damage caused by the Act of God (700). Oftentimes the relevant insurance company is the private homeowner insurance policy. The client may choose not to file a claim with the insurance company and, instead, pay for the selected services (720). This may occur if the deductible on the insurance company is so high that the generated repair estimate (704) would not be covered under the insurance policy or such that the Act of God is not covered by the terms of the insurance policy. In either case, the client has agreed to move forward with the work authorization and will pay for any of the necessary repairs to bring the roof back into a certifiable condition. Alternatively, if the client decides to file a claim with the insurance company, the claim and work authorization are assigned to a contractor (722). Here, the contractor receiving the claim and work authorization may be the same contractor that performed the inspection as long as contractor is registered with the roof maintenance system 10 and as a repairman. Otherwise, another contractor capable of performing the requisite repairs to the roof is automatically contacted and scheduled according to the processes described herein. If a different contractor is needed to process the claim and work authorization to repair the roof, such a contractor may immediately access the client account information in the database 12 with the local or remote software application. This is a tremendous benefit to the contractor for preparation purposes, even before arriving at the repair site. The documents in the database 12 are also fairly uniform by territory. In this regard, the contractor may immediately recognize the type of repair required to service the roof to within certification compliance based on the organization of the information in the database 12. In other words, a seasoned contractor can quickly find desired information in the client account based on employed standardization techniques. A new or repeat inspection is not necessary before the repair contractor can begin preparation to fix the roof.

Repair contractors are also preferably registered with the database 12 as being capable of filing insurance claims to recover at least partial payment of the losses covered by the homeowner insurance policy (724). Providing assistance in preparing such an insurance claim can be of great value to the client as the client may be inexperienced in filing such an insurance claim. The repair contractor will also submit with the claim a detailed explanation of all the damage and the costs associated with repairing the roof to a certifiable condition. Filing such an insurance claim (724) may occur automatically through use of the software application and the communication network 14. Naturally, this decreases the quantity of paper work shuffled between the contractor, the homeowner and the insurance company. This further enables the insurance company to more quickly respond to the claim. Moreover, the client need not rely exclusively on a roof inspector from the insurance company for an inspection report that may or may not provide as much detail as is required by the application software used in association with the roof maintenance system 10. Furthermore, this enables the contractor to quickly move to perform requisite emergency services (726), if applicable. Insurance policies often require mitigation of damages, such as tarping the roof, to prevent further damage. The client may also desire to pay for such selected emergency services (726) to avoid additional expenses from damages that may be caused by an unprotected roof. The client may also request that the contractor perform more than just the emergency services. In this case, the contractor changes the work order to reflect the additional work request (728). Also, any interior restorations that are necessary either under the insurance policy or at the request of the client are performed (730). The contractor then repairs the damage causing the leak. The repair should last at least until the end of the certification period (732). Accordingly, each of the steps (726)-(732) are performed to the extent necessary for the roof to pass the certification process. The contractor files the documented issues and resolution with the database (734) as a last step to ensure that the repair is properly documented with the roof maintenance system 10. This ensures that any subsequent repair or certification may be retrieved through the database 12 via the communication network 14.

FIG. 8 is a flow chart illustrating the steps for repairing a leaky roof caused by a third party and/or for non-insurance covered damage (800). Anticipated third parties that might cause such damage include neighborhood children playing upon the roof, electricians or other contractors performing services around the roof, etc. As with step (704), the contractor first generates a repair estimate (802). The repair estimate may include illustrations of the current roof conditions, notes correlating to the drawings or the condition of the roof, materials expenses for repairing the roof or associated labor rates. The contractor must determine whether there was any resultant damage due to roof failure (804). If there is no resultant damage caused by the third party or non-insurance covered damage, the client is requested to sign the work authorization based on the repair estimate (806). In the event that the client refuses to sign the work authorization, no work is performed (808) by the contractor. Subsequently, the certification is voided (810) and the database 12 automatically sends the client correspondence regarding the reasons for voiding the certification (812) in the same manner as was done with respect to step (712) in FIG. 7. The client must then decide whether to reinstate the work authorization (814). The correspondence includes information stating the reasons for voiding the certification (810) and options for reinstating the work authorization. In the event that the client fails to respond to the client correspondence or declines to reinstate the work authorization, the certification is terminated (816). Otherwise, the client reinstates the repair and agrees to pay for the selected certification services (818).

Alternatively, in the event that there is resultant damage (804) to the client property, it must then be determined whether the claim is to be transferred to the third party (820). Similar to steps (722) and (724) in FIG. 7, if the claim is to be transferred to either the third party or the insurance company of the third party, the work authorization is assigned to the contractor (822) in order to file a claim for payment of losses covered by the third party or the insurance company of the third party (824). The roof contractor may also decide to inform the insurance company of the client of the cause of the damage at which point the client's insurance company might pay for a portion of the loss and subrogate against the third party or the insurance carrier of the third party. The client must otherwise agree to pay for the selected certification services (818) in the event any losses are not covered by the insurance company of the client, the third party or the insurance carrier of the third party. The contractor then performs any requisite emergency services (826). The client may also request additional work to be performed on the roof such that the contractor changes the work order to reflect the additional work request (828). The contractor also performs any interior restorations (830) necessary to rectify the leaky roof and any damage caused thereby. The contractor should make the necessary repairs to stop the leak at least until the end of the certification period (832). Ultimately, the roof is repaired under steps (826)-(832) to the extent necessary such that the roof would pass the certification process as described above with respect FIG. 3. Then, the contractor files the documented issues and resolutions with the database (834). The information in the file may include the repair estimate generated by the contractor (802), the work authorization signed by the client (806), a voided certification (810) resulting from any refusal to sign the work authorization, a client reinstatement request (814) any claim transfer to the third party or the insurance company of the third party (820), any document associated with the inspection, repair and re-certification, or other related insurance forms or payment documents. Obviously, this enables the database 12 to collect a rich history of the roof, organized by client account in the database 12.

FIG. 9 illustrates a flow chart for diagnosing a leaky roof caused by normal wear and tear (900) to the roof. The first step is to determine whether there is any consequential damage (902), i.e. any damage other than damage to the roof itself. In the event that there is no consequential damage, the contractor makes the necessary repairs to stop the leak according to the warranty provisions in the certification at no cost to the client (904). The requisite documentation of the repair is then filed immediately with the database (906). At this stage, the documentation filed with the database 12 largely comprises the information obtained during the inspection process and information compiled to document the repair. For example, the software application requires the contractor to record notes and capture photographs describing the problem associated with the roof that caused the leak, thus requiring the repair. This information may be used at a later date in the event of a call back. The documentation is associated with the client account in the database 12 and is readily accessible by any contractor registered with the roof maintenance system 10 for any subsequent inspection, certification or repair.

Alternatively, if there is consequential damage other than damage to the roof, the contractor generates a repair estimate (908) in much the same manner as the repair estimate was created in steps (704) and (802) in FIGS. 7 and 8, respectively. That is, the contractor assembles information gathered as part of the inspection process and reports the conditions, including notes, photographs, the current state of the roof, and even the prior condition of the roof, to the client. The repair estimate should include materials expenses, labor rates or other expenses that demonstrate the full scope of the costs that may be incurred to fix the roof and any consequential damages as a result of the roof damage. The client must then decide whether to sign the work authorization based on the repair estimate (910) in order to have the contractor perform the requisite services to fix the roof. If the client does not sign the work authorization and does not otherwise agree to pay for the selected services, the contractor does not perform any work (912). Consequentially, the certification is subsequently voided (914) and the roof maintenance system 10 automatically sends the client correspondence regarding the reasons for voiding the certification (916). The client is then given the option to reinstate the work authorization (918), otherwise the certificate is terminated (920). Accordingly, steps (912)-(920) are performed in substantially the same manner as steps (708)-(716) in FIG. 7 and steps (808)-(816) in FIG. 8.

In the event that the client authorizes the repairs (910) or otherwise reinstates the work authorization (918), it is then determined whether the consequential damage is to be assigned to the insurance company of the client (922). The client may authorize the repair estimate or otherwise reinstate the repair based on agreeing to pay for the selected services or filing an appropriate insurance claim with the insurance policy held by the client. In the event that the client decides to file the consequential damage claim with the insurance policy, the next step is to assign the claim and the work authorization to a contractor (924). Similarly, the contractor files an insurance claim for payment of the losses covered by the client's insurance policy (926). Of course, steps (924)-(926) are substantially similar in operation to steps (722)-(724) and steps (822)-(824). If the client decides not to file an insurance claim with the insurance policy, the client must agree to pay for the selected services (928) for the contractor to repair the roof. Once either the insurance filing is finished (926) or the client otherwise agrees to pay for the selected services (928), the contractor proceeds to perform emergency services (930), if applicable, change the work order to reflect additional work requests by the client (932), perform interior restorations (934), if applicable, and make the necessary repairs to stop the leak at least until the end of the certification period (936). Again, steps (930)-(936) are substantially similar to those steps previously described with respect to steps (726)-(732) in FIG. 7 and steps (826)-(832) in FIG. 8. The contractor records the necessary changes to the roof and documents any repairs made to the roof for filing the documented resolution with the database (906). The documentation filed with the database (906) should adequately notify any subsequent inspector, certifier, repairman or other contractor as to the issues concerning the leak in the roof and the appropriate action taken to repair the roof such that it should not leak at least within the certification period.

As disclosed herein, the roof maintenance system 10 is a comprehensive network including the database 12, the communication network 14 and a local or remote software application that effectively governs and regulates the process for maintaining roofs. While the disclosure describes several preferred embodiments, a person of ordinary skill in the art will readily recognize that the roof maintenance system 10 may be used in a variety of ways not specifically described herein.

Although several embodiments have been described in detail for purposes of illustration, various modifications may be made to each without departing from the scope and spirit of the invention. Accordingly, the invention is not to be limited, except as by the appended claims.

What is claimed is:

1. A process for maintaining a roof, comprising the steps of:
receiving a maintenance request;
establishing an account in a database associated with the maintenance request;
notifying a contractor of the maintenance request;
communicating maintenance request information over a communication network to a software application accessible by the contractor;
establishing a service procedure in the database; and
regulating performance of the maintenance request by the contractor via the service procedure and the software application.

2. The process of claim 1, including the step of synchronizing the software application with the database over the communication network.

3. The process of claim 1, wherein the software application comprises a stand-alone computer program or an internet-enabled web browser.

4. The process of claim 3, including the step of uploading an updated service procedure to the stand-alone computer program or conveying the updated service procedure to the contractor through the internet-enabled web browser.

5. The process of claim 1, wherein the regulating step includes the step of diagnosing a leak with the service procedure and the software application.

6. The process of claim 1, including the step of alerting the contractor of a step in the service procedure that is incomplete.

7. The process of claim 6, wherein the alert comprises an audio and/or visual notification.

8. The process of claim 1, including the step of issuing a roof certification.

9. The process of claim 8, including the step of publishing the roof certification.

10. The process of claim 9, wherein the publishing step includes the step of preserving an unalterable copy of the roof certification in the database.

11. The process of claim 10, including the step of associating supplemental information with the unalterable copy of the roof certification.

12. The process of claim 8, including the step of registering the roof certification with a regulatory authority.

13. The process of claim 8, including the step of transferring ownership of the roof certification.

14. The system of claim 8, including the step of informing a roof certification holder by a telephone call, a text message, an email, or an automatically generated letter that the roof certification is about to expire or has already expired.

15. The process of claim 1, wherein the regulating step includes the step of denying a roof certification for failure to satisfy the service procedure.

16. The system of claim 1, wherein the communication network comprises an Internet, a telephone line, a cell phone communication network, or a wireless network.

17. The process of claim 1, wherein the regulating step includes the step of receiving service information from the software application.

18. The process of claim 17, including the step of aggregating service information from multiple contractors in the account in the database.

19. The process of claim 17, including the step of recording the contractor submitting the service information.

20. The process of claim 17, wherein the service information comprises a note, a picture, an observation resolution or a diagram.

21. The process of claim 1, wherein the communicating step includes the step of securing data transmission over the communication network by secure socket layer, hypertext transfer protocol secure, transport layer security or encryption.

22. The process of claim 1, wherein the maintenance request comprises a roof inspection, certification or repair request.

23. The process of claim 1, wherein the maintenance request information comprises a roof inspection, certification, repair or service history report or warranty associated with the account in the database.

24. The process of claim 1, including the step of charging the contractor for receiving the maintenance request notification.

25. The process of claim 1, wherein the notifying step includes the step of messaging, calling, texting or emailing the contractor.

26. The process of claim 1, including the steps of:
registering the contractor with the database; and
granting the contractor access to the database based on a contractor training record.

27. The process of claim 1, wherein the regulating step includes the step of preparing a repair estimate or a repair work order with the software application.

28. The process of claim 1, wherein the maintenance request comprises an email response or a text message response to a certification reminder.

29. The process of claim 1, wherein the contractor comprises an inspector, a repairman, or a builder.

30. The process of claim 1, wherein the regulating step includes the step of determining that the roof requires repair when the roof is currently leaking, the roof has a likelihood of leaking during a certification period, or when the roof leaks during the certification period and is in sufficient condition for repair until the end of the certification period.

31. The process of claim 30, including the step of repairing the roof to stop the leak at least until the end of the roof certification period.
